(19) United States
(12) Patent Application Publication
(10) Pub. No.: US 2009/0088088 A1
(43) Pub. Date: Apr. 2, 2009

(54) Personal Information Communication Device and Method

(75) Inventor: Ty Joseph Caswell, Zimmerman, MN (US)

Correspondence Address: MERCHANT & GOULD PC, P.O. BOX 2903, MINNEAPOLIS, MN, 55402-0903, US

(73) Assignee: Crick Information Technologies, Zimmerman, MN (US)

(21) Appl. No.: 12/251,251

(22) Filed: Oct. 14, 2008

Related U.S. Application Data
(63) Continuation-in-part of application No. 12/024,349, filed on Feb. 1, 2008.
(60) Provisional application No. 60/892,062, filed on Feb. 28, 2007.

(51) Int. Cl. H04B 1/38; G06F 3/048

(52) U.S. Cl. 455/90.1; 715/810

(57) ABSTRACT

Methods and systems for transmitting and receiving digital data are disclosed. In accordance with one aspect, a data communications device is disclosed. The device includes a handheld-sized housing containing circuitry including a powered region and an unpowered region. The powered region is configured to be operable in the absence of a connection to a computing system, the powered region including a programmable circuit and a wireless transceiver, the programmable circuit connected to the wireless transceiver for wirelessly exchanging files with another data communications device, the programmable circuit including a memory. The unpowered region is configured to be inoperable in the absence of a connection to a computing system, the unpowered region including a USB interface and a flash memory. The unpowered region is communicatively connected to the powered region.

### CROSS-REFERENCE TO RELATED APPLICATIONS

The present application claims priority as a continuation-in-part application to U.S. patent application Ser. No. 12/024,349, filed on Feb. 1, 2008, which claims priority to U.S. Provisional Patent Application No. 60/892,062, filed Feb. 28, 2007. The disclosures of each of these references are hereby incorporated by reference in their entireties.

### TECHNICAL FIELD

The present disclosure relates to methods and apparatus for data transmission. More specifically, the present disclosure relates to communication of digitized personal information.

### BACKGROUND

Cellular phones, personal digital assistants, and other handheld electronics are often configured to hold a variety of personal data, such as medical records, addresses of contacts, and other information specific to that user. For a variety of reasons, users of handheld electronics desire to share this information with others, whether it is to exchange personal information or contacts with a business associate, pictures with friends, or medical information with health professionals.

One particular situation in which such a need is felt is in a business setting where two or more businesspeople exchange paper business cards. Each individual typically carries a sufficient number of business cards to provide one for each of the other individuals present. Following the exchange of business cards, the cards are often misplaced or damaged, inhibiting the ability for the receiving businessperson to contact the individual identified on the card. Alternatively, businesspeople manually enter information from the business cards into their electronic “address book”, which is an inefficiently repetitive process of transferring large numbers of these small volumes of information—particularly for salespeople or other businesspeople contacting a large number of others in a given day.

In other situations, text, pictures, sound files or other files are shared, such as among teenagers at school. The various types of files can correspond to assignments shared among a group, or can correspond to personal information owned and/or controlled by the student. Files shared among students may be used in computers or other systems, such as for playback or editing.

For these and other reasons, improvements are desired.

### SUMMARY

The above and other problems are solved in accordance with the present disclosure by the following:

In accordance with one aspect, a data communications device is disclosed. The device includes a handheld-sized housing containing circuitry including a powered region and an unpowered region. The powered region is configured to be operable in the absence of a connection to a computing system, the powered region including a programmable circuit and a wireless transceiver, the programmable circuit connected to the wireless transceiver for wirelessly exchanging files with another data communications device, the programmable circuit including a memory. The unpowered region is configured to be inoperable in the absence of a connection to a computing system, the unpowered region including a USB interface and a flash memory. The unpowered region is communicatively connected to the powered region.

In a second aspect, a method of storing data associated with a data communications device is disclosed. The method includes connecting a data communications device to a computing system via a USB interface. The method further includes transmitting data selected for storage on the data communications device to a server remote from the computing system and identified by a header stored on the data communications device. The method also includes receiving a link generated by the server that uniquely identifies the data transmitted to the server and storing the link in a memory of the data communications device.

In a third aspect, a method of accessing data stored on a server and identified by a data communications device is disclosed. The method includes connecting a data communications device to a computing system via a USE interface, and transmitting links stored on the data communications device to a server identified by header data stored on the data communications device. The method further includes accessing identifying information about files associated with the links and displaying a user interface to a user, the user interface presenting the identifying information such that the files appear to be stored on the data communications device.

In a fourth aspect, a computer-storage medium for storing computer instructions capable of generating a user interface on a computing system when executed. The user interface includes a displayable field including a collection of file information record fields arranged in a generally circular orientation, the collection of file information record fields cyclically accessible in the displayable field and including at least one file record field displaying an image of information contained in a corresponding file held in a remote database, and a plurality of file information record fields displaying less than all of the information contained in corresponding file information records of the database.

### BRIEF DESCRIPTION OF THE DRAWINGS

FIG. 1 shows methods and systems for data receipt according to a possible embodiment of the present disclosure;

FIG. 2 shows methods and systems for data transmission according to a possible embodiment of the present disclosure;

FIG. 3 shows an exemplary communications network in which aspects of the present disclosure can be implemented;

FIG. 4A shows a second exemplary communications network in which aspects of the present disclosure can be implemented;

FIG. 4B shows a further exemplary communications network in which transferred files can be accessed;

FIG. 5 shows a schematic front plan view of an audible data communications device according to a possible embodiment of the present disclosure;

FIG. 6 shows a schematic front plan view of the audible data communications device of FIG. 5 with a protective cover removed;

FIG. 7 shows a schematic side plan view of the audible data communications device of FIG. 5;

FIG. 8A shows a front perspective view of a data communications device, with a cover removed, according to a further embodiment of the present disclosure;

FIG. 8B shows a front perspective view of the data communications device of FIG. 8A with cover attached, according to a further embodiment of the present disclosure;

FIG. 8C shows an end plan view of the data communications device of FIG. 8A according to a further embodiment of the present disclosure;

FIG. 8D shows a side plan view of the data communications device of FIG. 8A with cover attached, according to a further embodiment of the present disclosure;

FIG. 8E shows a top plan view of the data communications device of FIG. 8A with cover attached, according to a further embodiment of the present disclosure;

FIGS. 9A and 9B show a perspective schematic view of two data communications devices interfacing, according to the embodiment shown in FIGS. 8A-8E;

FIG. 10A shows a front perspective view of a data communications device, with a cover removed, according to a further embodiment of the present disclosure;

FIG. 10B shows a front perspective view of the data communications device of FIG. 10A with cover attached, according to a further embodiment of the present disclosure;

FIG. 10C shows an end plan view of the data communications device of FIG. 10A according to a further embodiment of the present disclosure;

FIG. 10D shows a side plan view of the data communications device of FIG. 10A with cover attached, according to a further embodiment of the present disclosure;

FIG. 10E shows a top plan view of the data communications device of FIG. 10A with cover attached, according to a further embodiment of the present disclosure;

FIGS. 11A and 11B show a perspective schematic view of two data communications devices interfacing, according to the embodiment shown in FIGS. 10A-10E;

FIGS. 12A and 12B show a perspective schematic view of opposing sides of a printed circuit board useable in the systems shown in FIGS. 5-11;

FIG. 13 is an exemplary schematic of the circuitry of an audible data communications device according to a possible embodiment of the present disclosure;

FIG. 14 is a further schematic of circuitry of a data communications device according to a further possible embodiment of the present disclosure;

FIG. 15 shows an exemplary data packet communicated using the methods and systems described herein;

FIG. 16 shows a further exemplary data packet communicated using the methods and systems described herein;

FIG. 17 shows a further exemplary data packet communicated using the methods and systems described herein;

FIG. 18 illustrates interface circuitry for two communicating data communications devices, according to a possible embodiment of the present disclosure;

FIG. 19 illustrates a block of nonvolatile memory segmented into shared and private sectors, according to a possible embodiment of the present disclosure;

FIG. 20 illustrates an example user interface generated on a computing system for setting user information and file sharing information according to a possible embodiment of the present disclosure;

FIG. 21 illustrates an example user interface generated on a computing system interconnected with a data communications device according to the various embodiments of the present disclosure;

FIG. 22 illustrates a flowchart of methods and systems for sharing data in a sector of memory of the various data communications devices of the present disclosure;

FIG. 23 illustrates a further possible embodiment of a data communications device;

FIG. 24 is a schematic diagram of directional wireless data transfer, useable to implement aspects of the present disclosure;

FIG. 25 is a schematic block diagram of portions of a data communications device according to a further possible embodiment of the present disclosure;

FIG. 26A is a schematic block diagram of portions of a data communications device according to a further possible embodiment of the present disclosure;

FIG. 26B is a schematic block diagram of portions of a data communications device according to a further possible embodiment of the present disclosure;

FIG. 27 is a diagram of a file transfer operation useable to implement certain aspects of the present disclosure;

FIG. 28 is a schematic block diagram of a network in which a data communications device can be used, according to a possible embodiment of the present disclosure;

FIG. 29 shows an example user interface displaying files accessed using the data communications device, according to a possible embodiment of the present disclosure;

FIG. 30 shows an example user interface displaying user settings selectable with respect to data access from a data communications device, according to a possible embodiment of the present disclosure;

FIG. 31 shows a further example user interface displaying files accessible using the data communications device and a computing system, according to a possible embodiment of the present disclosure;

FIG. 32 is a flowchart illustrating methods and systems for data access and synchronization useable in the network of FIG. 28;

FIG. 33 is a flowchart of methods and systems for uploading data to a remote database for association with a data communications device, according to an aspect of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many embodiments possible.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to methods and systems for transfer of digital data, such as personal information. The methods and systems disclosed generate a signal, based on one or more communications protocols known in the art. The signal can be, in various embodiments, an audible signal, an optical signal, a radio signal, or a conducted electrical signal. The term audible signal as used herein relates to sounds emitted at a frequency within the audible range of a human listener, which do not form words of a user-recognizable language. The term optical signal as used herein relates to signals transmitted over optical communication means, such as through use of fiberoptic cables or free space optical transmission (e.g. infrared communication). The systems and methods can be implemented in a handheld device, such as a handheld memory device, cellular telephone, cordless telephone, personal digital assistant, or other portable electronic telecommunications device. A typical embodiment would be a handheld memory device, such as a USB memory device.

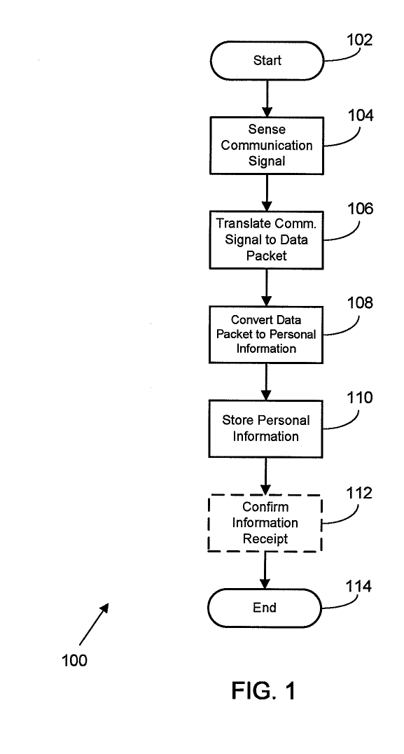

Referring now to FIG. 1, methods and systems for data receipt are shown according to a possible embodiment of the present disclosure. The system 100 shown operates to receive data, such as audibly emitted digital data carried on sound waves passing through the air or via some combination of wired speakers and air wave transmission. The system 100 can be embodied in any of a number of handheld devices, such as a credit card sized device, a miniature flash memory drive having a Universal Serial Bus (USB) interface, a cellular telephone, or some other mobile electronic device. In certain embodiments, the system as described is performed within a USB flash drive device.

The system 100 is instantiated at a start module 102. Operational flow proceeds to a sense module 104. The sense module 104 detects digital data embodied in a transmission medium. In certain embodiments, the transmission medium can be sound waves passing through the air, and can be implemented using a receiver and various analog and digital circuitry configured to filter out sounds of unwanted frequencies, preserving sounds within a frequency band in which data transmission is expected. In further embodiments, the transmission medium can be an infrared signal transmitted through the air, or an optical signal transmitted through a fiberoptic junction. Additionally, direct wired or radio frequency communication can be employed as well.

In a possible embodiment, data transmission within the system 100 occurs in all or part of the useable bandwidth from about 200 Hz to about 3400 Hz of standard POTS phone lines; alternately, all or a portion of the audible bandwidth of a cellular telephone transmission may be used. Other frequencies and ranges of frequencies are usable as well, and can be employed selectively based on the method and medium of transmission selected.

In a possible embodiment, the sense module 104 senses the presence of a data signal (e.g. sound waves in the case of audible transmission) and automatically reacts by activating the remainder of the modules in the system 100. In a further embodiment, a user activates the sense module 104 by pressing a button or otherwise activating the system 100. In such an embodiment, the sense module 104 begins attempting to sense transmitted digital data upon user activation.

Operational flow proceeds to a translation module 106. The translation module 106 translates the received signal to 1's and 0's, forming a data packet. The translation module 106 implements a communications protocol that relates the received signal to a digital representation of that signal. For example, the translation module 106 can translate digital data from an audible signal (sound wave), infrared signal (optical), wireless radio frequency signal, or direct wired analog signal. In certain embodiments, the communications protocol standardizes data transmission within the system 100 in all or part of the useable bandwidth from about 200 Hz to about 3400 Hz of standard POTS phone lines. In various other embodiments, the system 100 uses all or a portion of the audible bandwidth of a cellular telephone transmission.

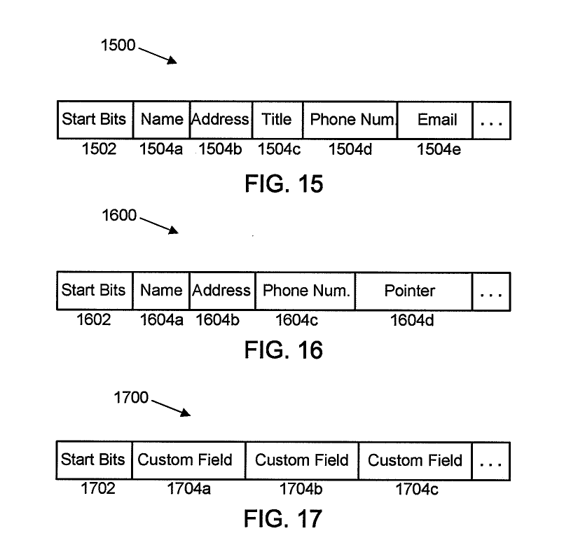

Operational flow proceeds to a conversion module 108. The conversion module 108 converts the digital bit stream to useable data. In a possible embodiment, the system 100 may be preconfigured to include a specified number of bits representing a first field, a second specified number of bits representing a second data field, and so on. In a further possible embodiment, a header data field specifies the number and length of the data fields. Example data fields are described below in conjunction with FIGS. 15-17.

Operational flow proceeds to a storage module 110. The storage module 110 stores the personal information in a memory of a handheld device. The storage module also optionally organizes various information received by the system 100 based on the type of information received as well as alphabetically or using some other organization system within each type of information. In various embodiments, the memory of the handheld device can be a flash memory or other persistent memory in which personal information is saved.

Operational flow proceeds to an optional confirmation module 112. The confirmation module 112 confirms to a user that the system 100 successfully acquired and stored data. The confirmation module 112 can do this in any of a number of ways. In one embodiment, the confirmation module 112 activates an indicator, such as a light emitting diode or other visible signal, which in turn notifies the user. In a further embodiment, the confirmation module 112 emits a readily recognizable audible sound that a user will recognize as indicating successful receipt of information. In such an embodiment, the audible sound may be implemented as a sound that is filtered by the sense module 104 such that a feedback loop is not created based on output of the sound, where sound waves are used for data transmission.

Operational flow terminates at an end module 114, which corresponds to completion of execution of the system 100.

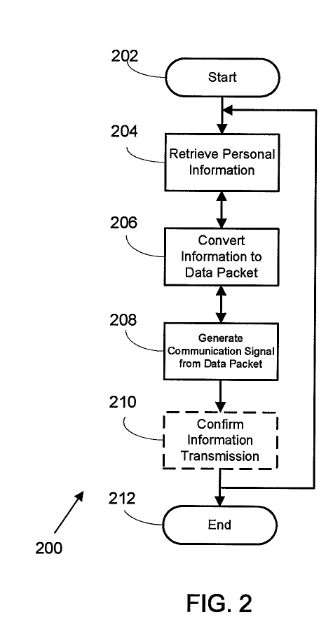

Referring now to FIG. 2, methods and systems for data transmission are shown according to a possible embodiment of the present disclosure. The system 200 shown, in general, performs the complementary function to the system 100 of FIG. 1, and is designed to prepare and transmit digital data using a selected transmission protocol and media, generally one complementary to the protocol and media used in the system of FIG. 1. For example, digital data can be prepared and transmitted at a variety of speeds and in a variety of formats on audible (sound) waves, optical signals, electrical signals, or radio frequency signals. The system 200 can therefore also be embodied in any of a number of handheld devices, as described above.

The system 200 is instantiated by a start module 202. The start module 202 corresponds to a user pressing a button or otherwise activating the handheld device, triggering the process to prepare and transmit data using a handheld device.

Operational flow proceeds to a retrieve module 204. The retrieve module 204 reads the memory of a handheld device and selects the information that the user desires to transmit to another device. The information can, for example, be business contact information typically found on a business card, or media files to be shared by friends and family. The information can also, be, for example, email messages, website addresses/links, credit card information, or multimedia files, including image or sound files. Other information can be retrieved as well, depending upon the types and file sizes of data stored on the handheld device, as well as the data transmission speed of the system 200.

Operational flow proceeds to a conversion module 206. The conversion module 206 forms the data retrieved from the memory of the handheld device into a data packet, as necessary for transmission under any applicable transmission protocol chosen. Exemplary data packets are shown below in FIGS. 15-17.

Operational flow proceeds to a generation module 208. The generation module converts the data packet into a signal embodied on the selected media of transmission. For example, the generation module 208 can transform the digital electrical signals of a device to the desired medium for transmission, such as an audible transmission, optical transmission, or electrical transmission. The generation module 208 performs the inverse operation of the translation module 106 of FIG. 1, in that it forms audible, optical, or other types of sounds based on data packets previously stored in a handheld device on which the system 200 operates.

Operational flow proceeds to an optional confirmation module 210. The confirmation module 210 optionally provides an indication to a user of a device in which the system 200 operates that data was successfully transmitted. The confirmation module 210 can do so, for example, by emitting a recognizable sound or activating an indicator such as a light emitting diode.

Operational flow terminates at an end module 212 that corresponds with completion of transmission of data and completion of execution of the system 200.

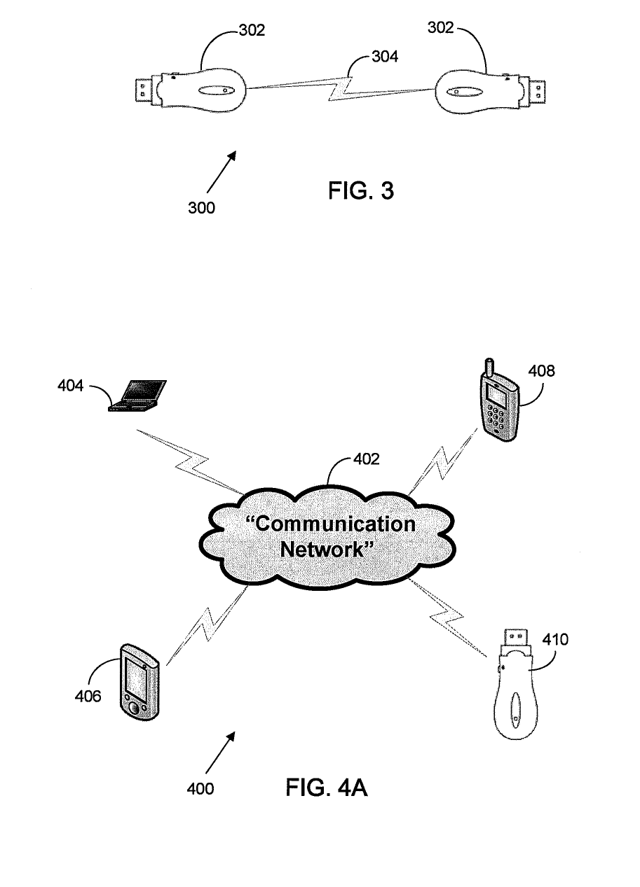

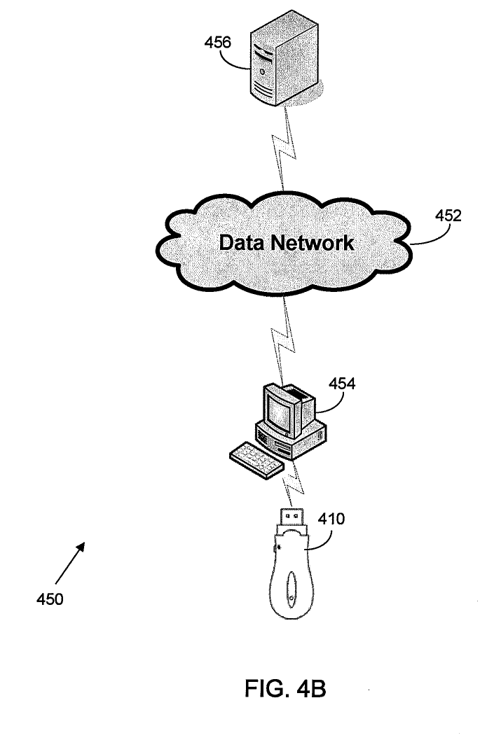

Now referring to FIG. 3, an exemplary communications network 300 is shown in which aspects of the present disclosure can be implemented. The network 300 includes two handheld devices 302 in bi-directional communications over a communication link 304. The handheld devices 302 are shown as two identical handheld devices, shown below in FIGS. 4-6. However, additional types of handheld devices can be used as well, and combinations of various types of handheld devices are possible.

The communications link 304 shown includes a sound wave, preferably traveling through air, over which audible communication of the digital data occurs. The communications link 304 can include various other wired or wireless data transmission methodologies upon receipt by other devices, such as by using various Internet or wireless transmission protocols known in the art. For example, the communications link 304 may include a sound wave transmitted from a first handheld device 302, which is in turn detected by an intermediate device, transduced to an electrical signal, then output as a sound wave at a separate location using a second transducer so as to be sensed and received at a second handheld device 302.

In further embodiments, the communications link 304 can be embodied in other types of communications media. For example, the communications link 304 can be an optical link between two handheld devices 302, or can be a wired or wireless electrical link. Additional possibilities for the network 302 are possible as well.

FIG. 4A shows a second exemplary communications network 400 in which aspects of the present disclosure can be implemented. The communications network 400 is intended to illustrate the point made above; namely, that various types of devices can communicate using any of a variety of types of communication links, or a mixture thereof. One example of such a link is an at least partially audible sound network. The network 400 includes a communication link 402 interconnecting a variety of devices, such as a personal computer 404, a personal digital assistant 406, a cellular telephone 408, or a handheld memory device 410. Additional devices are possible as well. In various embodiments, the communication link is a standard of communication allowing communication by various wired or wireless media, such as a sound wave communication link, infrared communication link, wireless (RF) communication link, or wired communication link.

Any of the devices 404-410 can communicate with any of the other devices over the communication link 402, such as by using the systems disclosed above in FIGS. 1-2. Further, when one device transmits information the remaining devices can all sense that information when placed within range that those other devices can audibly, electrically, optically, or otherwise detect the sound emitted from the first device.

FIG. 4B shows a further exemplary communications network 450 in which aspects of the present disclosure can be implemented. The communications network 450 is arranged to illustrate a method of accessing files for which pointers are passed among data communications devices. The communications network 450 uses a standard internet connection 452 connecting a personal computing system 454 with a server system 456 to access files referenced on a data communications device, such as a USB flash drive. The communications network 450 includes a data communications device, such as the handheld memory device 410 as previously described. The handheld memory device is electrically connected to a personal computing system 454, such as through a USB port. In this embodiment, the handheld memory device 410 can store files and can also store reference identifiers to specific media files. By using such an embodiment of the system, the various handheld memory devices described herein can transmit either files or can transmit pointers to those files that are stored remotely, such as on a server system 456. When the pointer is transmitted between two devices, a user of the device to which the pointer is transmitted can then access the data by connecting the handheld memory device 410 to a computing system (e.g. computing system 454) and accessing the file stored on the server 456 by reference to the pointer stored on the device.

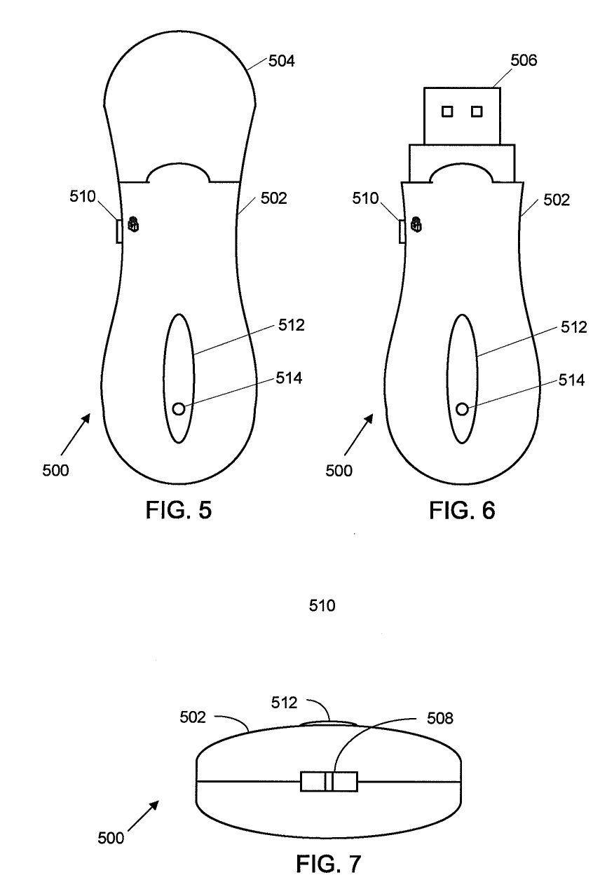

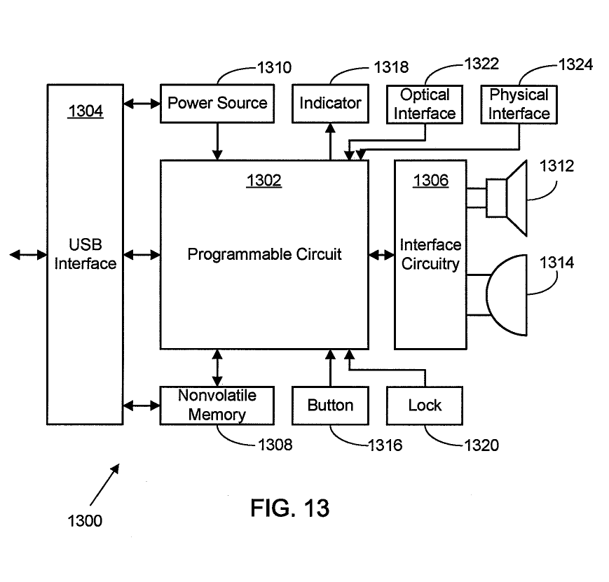

FIGS. 5-7 show a data communications device 500 according to a possible embodiment of the present disclosure. The data communications device 500 is one example of a handheld device in which the systems of FIGS. 1-2 can be implemented. The device 500 incorporates one or more of various audible, electrical, and optical data transmission/receipt features with data storage and transmission features, as described below and in conjunction with FIG. 13.

The data communications device 500 includes a housing 502 configured to fit in the hand of a user. The housing 502 can be manufactured from any of a variety of substantially rigid materials, such as plastic or metal. The housing 502 is contoured to fit the hand of a user, with a narrow center portion and flared ends.

The housing includes a cover 504 at a top end of the housing to protect an electrical interface 506, seen in FIG. 6. In the embodiment shown, the electrical interface 506 is a Universal Serial Bus (USB) interface configured to be plugged into a USB port for data and power transfer between the device 500 and other computing equipment, such as a personal computer. The electrical interface 506 can be configured to interface with a nonvolatile memory residing within the interior of the housing 502, such as a flash memory or miniaturized hard drive configured for data storage. Additional circuitry can be included within the housing as well, and can be externally connected to other electronic/computing equipment via the electrical interface 506.

In a possible embodiment, the electrical interface has a top edge that is curved to be outwardly convex (shown as a flat edge in FIG. 5), which may be considered more ergonomically pleasing if required to be held near the ear of an individual using the device 500. Other shapes are possible as well.

A port 508 at the base end of the housing 502 allows sound, light or radio waves to enter and exit the housing 502 of the device 500. The port 508 optionally includes two openings. In the case that the port is used for audible communication, one of the openings can be configured to transmit audible sounds and one can be configured to receive audible sounds. In the case that the port is used for infrared or other optical transmissions, one opening or optical connection can be used for an LED or other optical transmitter, while another opening can be related to a photodetector or other optical receiver. Other configurations of the port are possible as well, generally relating to the method/medium of transmission of data.

Additionally, a second port can be integrated into the electrical interface 506 at the top end of the device 500, such that the send and/or receive functions produce audible sounds emitted from the portion of the device 500 including the electrical interface 506. In one embodiment, both the send and receive functions are located at the end of the device 500 including the electrical interface 506. In a second embodiment, one of the send and/or receive functions occurs at the electrical interface 506 and the complementary function occurs at the port 508. In a further embodiment, both functions occur at both locations.

A lock switch 510 located along a side edge of the housing 502 allows a user to selectively lock the device 500 such that one or more functions of the device 500 is deactivated. In one embodiment, the lock switch 510 deactivates the electrical interface 506, preventing data communication with external computing devices. In a further embodiment, the lock switch 510 deactivates at least one of the send and/or receive functions of the device 500, such that various extraneous sounds are not perceived by the device to be data transmission. Combinations of these functions, or multiple lock switches, are possible as well.

An activation button 512 located along a front face of the housing 502 activates data transmission via an audible signal. A user, by depressing and optionally holding down the activation button, activates a method of audibly transmitting digital data, such as the method described above in conjunction with FIG. 2. An indicator 514 embedded within the activation button 512 indicates to the user when digital data has been successfully sent or received. Example uses of the indicator 514 are discussed above in connection with FIGS. 1-2.

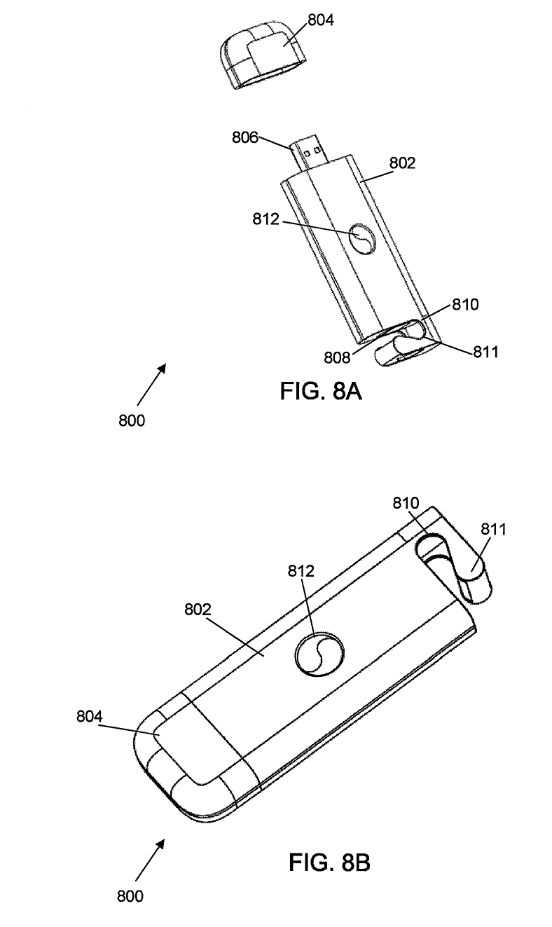

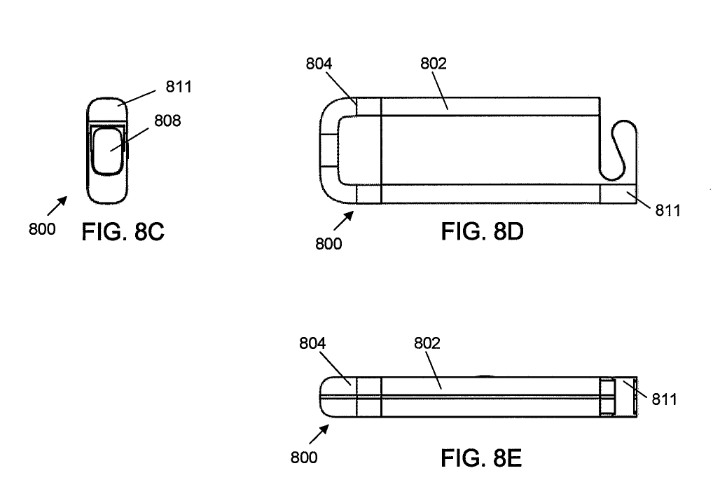

FIGS. 8A-8E illustrate a data communications device 800 according to a further embodiment of the present disclosure. The data communications device 800 can generally incorporate the various features of the device shown in FIGS. 5-7 above; however, in certain embodiments, additional or different methods of communication can be employed. In the embodiment shown, the data communications device 800 includes a housing 802 and a cover, shown as cap 804, configured to fit over and protect an electrical interface, such as the USB connector 806.

In the embodiment shown, the device 800 includes a port 808 for communication with another like device. The port 808 is shown as an infrared data communication port; however, in various other embodiments of the present disclosure, the port can provide a direct wired or audible data communication system. In certain embodiments, the port 808 provides bidirectional communication between devices; in further embodiments, the port provides two-way unidirectional (e.g. half-duplex) communication according to any of a number of formats, as described below.

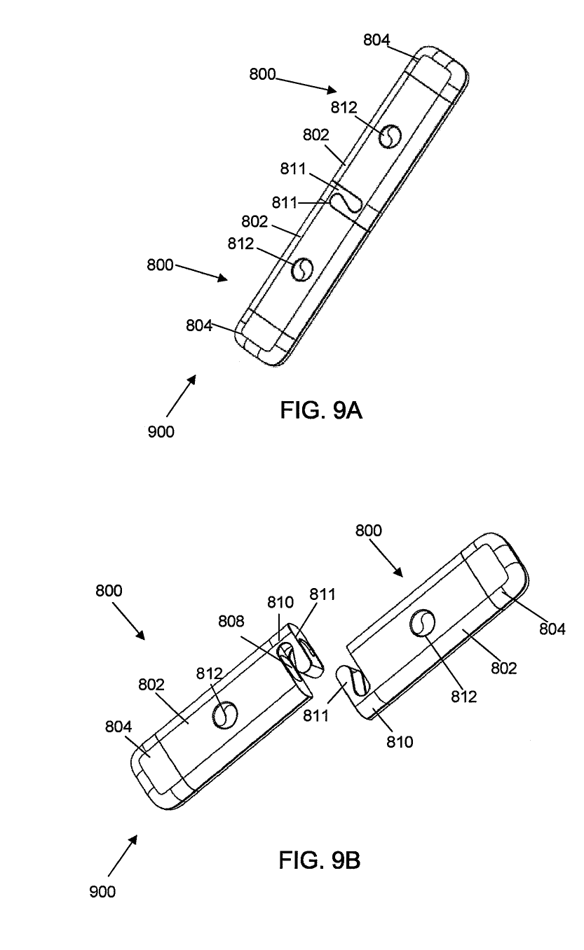

The housing 802 is configured in a “keyed” manner around the port 808 such that two ports only connect together in a single orientation that corresponds with aligning the input and output ports of the device with the output and input ports, respectively, of another device. In the embodiment shown, the housing 802 includes an interconnect structure 810 extending past the port 808 and configured to mate with a complementary structure on another device. The interconnect structure 810, as shown, includes a tab 811 extending past the port 808 and arranged to connect to a complementary tab on another device 800 by laterally sliding the two devices together. The tab 811 includes an opening arranged to allow infrared signals or other types of signals (depending upon the specific configuration of the communication system using the port 808) to pass from one device to another when interconnected. A device-to-device communication system 900 illustrating the orientation and connection of two such devices 800 is shown in FIGS. 9A and 9B. When connected, the joined interconnect structures 810 of the two devices 800 form a surrounding wall around two facing ports 808, the wall formed by the interconnection of the tabs. This wall isolates the ports 808 of joined devices from environmental interference.

The device 800 also includes a button 812 centrally located on a side of the housing. The button 812 activates data communication of the device 800 through use of the port 808. A user will generally choose to press the button on one or both devices when two devices are interconnected, such as is shown in FIG. 9A. In certain embodiments, the button 812 is configured to be pressed to either send or receive data; in other embodiments, the button need only be pressed to send data, with data receipt detected automatically by the complementary connected device.

The embodiment of the device 800 can optionally include additional functionality, such as a power switch or lock switch as shown in FIGS. 4-7. Furthermore, in other embodiments added ports may be included to allow both infrared and another type of data communication, such as a wired or audible data communication or an RF data communication system.

In the embodiment shown, the port 806 is located on an opposite side of the housing from the electrical (e.g. USB) interface. In certain other embodiments, the cap 804 includes a port, such as port 808, allowing the device 800 to communicate through the port by connecting the port to the electrical interface (e.g. via connection to the USB connector 806).

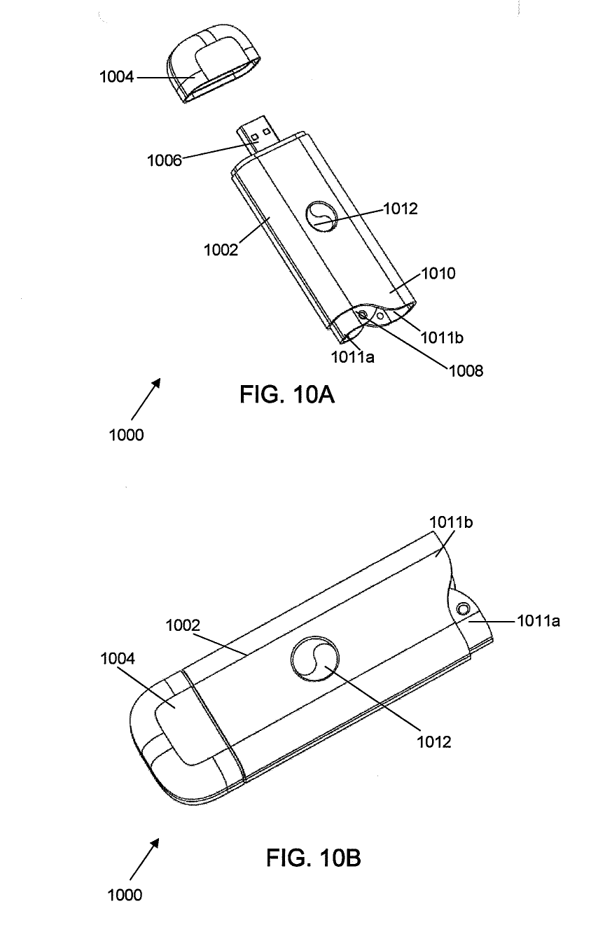

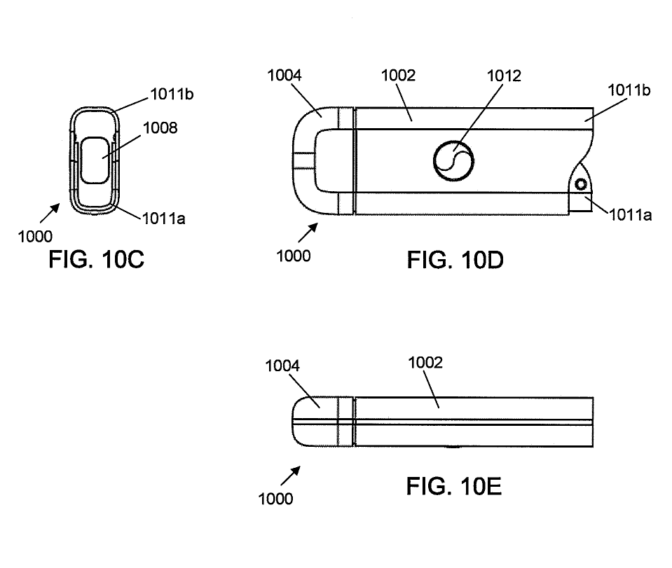

FIGS. 10A-10E illustrate a further embodiment of a data communications device 1000. The data communications device 1000 generally corresponds to the device 800 of FIGS. 8A-8E, and has a housing 1002, cover 1004, electrical interface (shown as USB interface 1006), and a port 1008. These components generally correspond to like-numbered components of FIGS. 8A-8E, above. However, in the embodiment shown, the housing 1002 is formed to provide a different interconnect structure 1010 which two flanges 1011a, 1011b placed along a portion of the perimeter around the port 1008 are arranged to interlock using a friction-fit connection. The two flanges include an inner flange 1011a and an outer flange 1011b, arranged to interlock in a friction-fit or snap-fit configuration. When the two data communications devices 1000 are connected, communications ports 1008 face each other to facilitate direct port-to-port communication. A button 1012, analogous to the button 812, is included in the device 1000 and is centrally located on a side of the housing 1002.

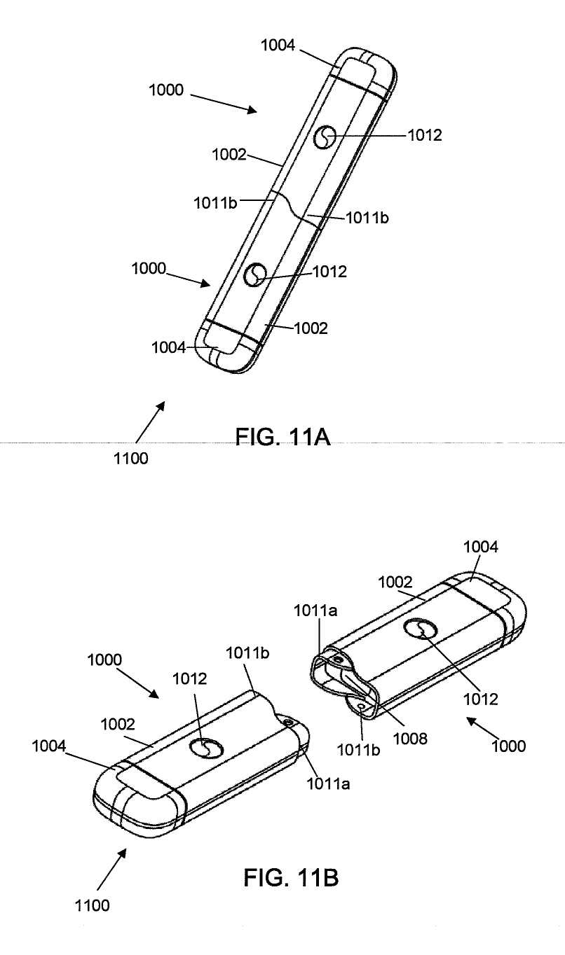

A system 1100 in which two devices 1000 are interconnected in a proper orientation is shown in FIGS. 11A and 11B. When connected, the system 1100 forms a surrounding wall around two facing ports 1008, the wall formed by the interconnection of the flanges 1011a-b on both devices 1000.

The embodiment of the device 1000 can also optionally include additional functionality, such as a power switch or lock switch as shown in FIGS. 4-7, or the other features discussed in conjunction with FIGS. 8-9. Furthermore, in other embodiments added ports may be included to allow both infrared and another type of data communication, such as a wired or audible data communication or an RF data communication system.

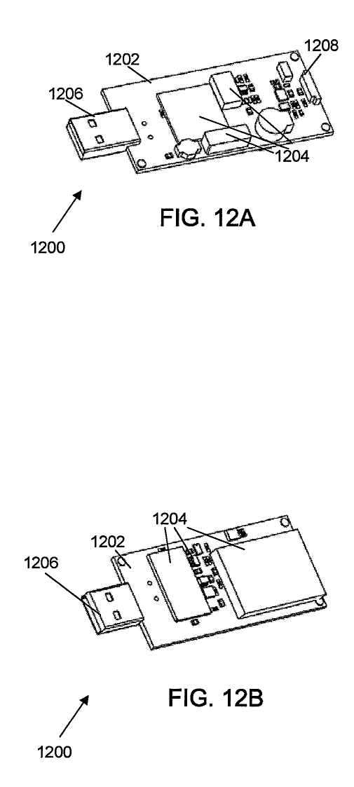

FIGS. 12A and 12B illustrate front and rear perspective views of example circuitry 1200 useable in the data communications devices of FIGS. 5-11, according to a possible embodiment of the present disclosure. In this embodiment, the circuitry 1200 generally provides the functionality of a USB flash drive device, in that it includes a nonvolatile memory and USB interface to that memory. The circuitry 1200 includes a printed circuit board 1202 upon which a variety of circuitry 1204 is mounted. The circuitry 1204 generally includes the nonvolatile memory and a programmable circuit able to execute firmware that executes the various methods and systems described in FIGS. 1-2, above. In various embodiments, the circuitry 1204 can include, for example, various circuitry configurations such as the example circuitry arrangements shown in FIGS. 13-14 and FIG. 18, below.

An electrical interface, shown as USB connector 1206, is connected at one edge of the printed circuit board 1202, and is interfaced to the circuitry 1204 to allow data communication between the circuitry (and nonvolatile memory included therein) and a computing system electrically connected to the interface. A port 1208 located on an edge of the printed circuit board 1202 opposite to the USB connector provides a second method of communication to share data stored in at least a portion of the nonvolatile memory. The port 1208 can communicate via a variety of media, such as by using sound waves, infrared or other optical communication, radio/wireless communication, or by direct electrical connection.

In certain embodiments, although the entirety of the nonvolatile memory can be accessed using the USB interface 1206, only a portion of the memory is accessible via data communication using the port. In this sense, a portion of the data stored in the nonvolatile memory is “private” (i.e. inaccessible via communication with the port) and a portion is “public” (accessible via the port).

FIG. 13 shows an exemplary schematic of circuitry 1300 of an audible data communications device according to a possible embodiment of the present disclosure. The circuitry 1300 can be implemented, for example, in the device 500 shown in FIGS. 5-7 or the other devices 800 and 1000 shown in FIGS. 8-11, as shown in the circuitry of FIGS. 12A and 12B. Alternately, the circuitry can be implemented in a cellular telephone, personal digital assistant, or other handheld or portable electronics.

The circuitry, in general includes a programmable circuit 1302, an electrical interface 1304, an acoustic interface 1306, a memory 1308, and a power source 1310. The circuitry optionally includes an optical interface 1322 and a physical interface 1324 as well.

The programmable circuit 1302 controls overall operation of the audible data communications device in which it is located. The programmable circuit includes a digital signal processor configured to perform the analog to digital and digital to analog conversions necessary to convert the digital data packets to audible sound.

The programmable circuit 1302 also optionally includes various additional operational logic configured to access memory, and to respond to the various interfaces to the programmable circuit. In one embodiment, the programmable circuit 1302 includes a microcontroller. The microcontroller can be programmable in any of a number of programming languages, such as assembly language, C, or other low-level language. In alternate embodiments, the programmable circuit 1302 includes a programmable logic device (PLD) such as a field programmable gate array (FPGA), Complex Programmable Logic Device (CPLD), or Power ASIC (Application Specific Integrated Circuit). In these embodiments, a hardware description language such as Verilog, ABEL, or VHDL defines operation of the programmable circuit 1302.

The electrical interface 1304 provides an electrical and data connection between the circuitry 1300 and connecting circuitry of an external or additional computing device. In the embodiment shown, the electrical interface 1304 is a USB interface, which allows the system to both (1) transmit and receive data along the interface, and (2) receive electrical power, such as to power the system or charge a power source (i.e., a battery) included in the circuitry 1300.

The acoustic interface 1306 includes various circuit elements that may be necessary, depending upon the chosen implementation of the programmable circuit, to convert the analog signals received from the programmable circuit 1306 and to convert those signals to audible sounds, and vice versa. The acoustic interface includes a transducer 1312 configured to output sounds based on analog signals received from the programmable circuit 1302, and a receiver, such as a receiver 1314, configured to receive sounds and convert those sounds to analog electrical signals recognizable to the electrical circuit. In various possible embodiments, the frequency response of the transducer 1312 allows performance at one or more frequencies, such as from about 200 Hz to about 3400 Hz of standard POTS phone lines, or within the audible bandwidth of a cellular telephone transmission.

The transducer 1312 and receiver 1314 can be arranged in a number of ways to reduce interference between them and prevent sound feedback in the circuitry 1300. In one possible embodiment, the transducer 1312 is located remotely from the receiver 1314, such as at opposite ends of a device in which they are located. In a further possible embodiment, a system incorporating these components may have dedicated ports for each of the transducer 1312 and receiver 1314. In yet a further possible embodiment, the transducer 1312 and receiver 1314 are arranged concentrically to minimize feedback. In such a configuration, the transducer 1312 may be formed in a logarithmic acoustic shape. The receiver 1314 can be directly coupled to a transducer 1312 and formed in a complementary shape to receive directionally oriented sound emitted from a transducer 1312 in a complementary audible data communications device. One or more of these configurations may be used in any one device incorporating the acoustic interface 506.

The memory 1308 can be any of a variety of preferably non-volatile, electrically erasable and reprogrammable memories. In a possible embodiment, the memory 1308 is a flash memory. Other memory technologies are integrable into the circuitry 1300 as well.

The power source 1310 provides electrical power to the circuitry 1300 when the circuitry is not connected to an external power source via the electrical interface 1304. In a possible embodiment, the power source 1310 is a compact, rechargeable battery. The power source can preferably be recharged using the electrical interface as well. However, in a further embodiment, the power source 1310 is replaceable.

The circuitry 1300 also includes an activation button 1316, an indicator 1318, and a lock switch. The activation button 1316 allows a user to activate one or more functions incorporated into the circuitry 1300. In one embodiment, the activation button activates the programmable circuit 1302 and acoustic interface 1306 to cause data stored in the memory 1308 to be transmitted audibly via the transducer 1312. In a further embodiment, the activation button also activates the acoustic interface 1306 to allow receipt of audible sounds at the receiver 1314 and conversion to digital data.

The indicator 1318 provides a visible indication to a user of the status of the device in which the circuitry 1300 is embodied. The indicator can be configured to be activated upon successful audible receipt and/or transmission of the digital data. The indicator can also be configured to indicate when the power source 1310 needs to be replaced, or can indicate a state corresponding to when the electrical interface 1304 is connected to an external electronic device (such as when the circuitry is connected via the USB connection to recharge the power source 1310).

The lock switch 1320 locks one or more of the functions of the circuitry so as to prevent unintentional data transmission/receipt. In one embodiment, the lock switch 1320 activates and deactivates the receiver 1314 or one or more components of the acoustic interface 1306, preventing translation of one or more unintentional sounds to digital data, which would result in storage of extraneous data within the memory 1308. In a further embodiment, the lock switch 1320 activates and deactivates both the receiver 1314 and the transducer 1312, preventing both transmission and receipt of audible data. In still other embodiments, the lock switch 1320 prevents reading from or writing to the memory 1308, or transmission of data along the electrical interface 1304. Combinations of these functions may be implemented with the lock switch 1320 as well.

The optional optical interface 1322 provides an alternate method by which data can be communicated between data communications devices. The optical interface 1322 is configured to send and receive data analogously to the acoustic interface 1306. The optical interface 1322 can be used as a selectable alternative to the acoustic interface 1306 for implementations in which audible sounds are not desired. In one embodiment, the optical interface 1322 is an infrared transmitter/receiver. In such an embodiment, the optical interface 1322 transmits and receives data in all or part of the useable bandwidth provided by the selected infrared transmitter/receiver.

In certain embodiments, the optical interface 1322 can be used in conjunction with the acoustic interface 1306 to transmit data at a higher data rate. In still further embodiments, the optical interface 1322 can completely replace the acoustic interface 1306 and the transmitter 1312 and receiver 1314 in data communications.

The optional physical interface 1324 provides a further alternate method by which data can be communicated between data communications devices. The physical interface 1324 is configured to send and receive data analogously to the acoustic interface 1306 and the optical interface. The physical interface can be used as a further selectable alternative to the other interfaces, such as where the other interfaces are non-operable. In such embodiments, the physical interface can correspond to electrical circuitry and electrical contacts capable of forming a digital or analog data connection between two like devices.

In a possible embodiment, the circuitry 1300, and the electrical interface 1304 in particular, can be used to program the programmable circuit 1302 or to place information into memory 1308 regarding the type and/or size of data to be transmitted (as well as the data itself). In such an embodiment, software may be provided to a user that can be used to access and define the various fields of the data packets or, in general, the data to be transferred.

In a further possible embodiment, the circuitry 1300 is configured such that, upon connection to an external computing device via the electrical interface 1304, data is imported into the memory 1308, such as e-mail messages, contact information, websites, and other personal information collected on a personal computer can be shared between devices including the data transmission systems described herein.

In yet another possible embodiment, the circuitry 1300 is configured such that, upon connection to an external computing device via the electrical interface 1304, data is exported from memory 1308 such that the information held within the memory 1308 is duplicated onto a computing device, such as a personal computer, for further use and distribution.

In still a further possible embodiment, the circuitry 1300 is configured to allow only partial access of data in the nonvolatile memory 1308 to one or more of the interfaces 1306, 1322, 1324 that are not the direct electrical, USB interface 1304. In such an embodiment, a user of a computing system connected to the circuitry 1300 can choose to place files or other data in either a portion of memory accessible via the interfaces (i.e. a public portion of memory) or in a portion only accessible via the USB interface (i.e. a private portion of the memory).

Optionally, a feedback mechanism 1326 can be included into the circuitry 1300, and provides an indication to a user of an event occurring in the data communications device. In embodiments including such a mechanism, the mechanism 326 can be triggered by the programmable circuit 1302 to actuate upon any of a number of events occurring in the device. For example, the programmable circuit could activate the feedback mechanism upon receipt of confirmation of a successfully communication session with a like device, or successful transmission of data. Other events could trigger actuation of the feedback mechanism as well.

In various embodiments of the circuitry, the feedback mechanism 1326 can take a variety of forms. In one embodiment, the feedback mechanism is a vibrating mechanism configured to activate upon successful transmission of information from the device and receipt of an acknowledging message in return from another data communications device. The vibrating mechanism can, when activated, cause the data communications device to vibrate in a manner detectable by a user holding the device. This can be particularly useful, for example, in loud environments or other situations in which the device cannot be readily heard or it cannot be otherwise determined that data communication occurred successfully.

Using the systems disclosed herein, such as the circuitry 1300 implementing methods such as those shown in FIGS. 1-2, it is preferable that the duration of communication between two or more devices be of a limited duration so as to maximize the convenience of the methods and systems for data transfer. It is further preferable that robust communications protocols be used for audible data transfer due to possible signal noise and other interfering effects.

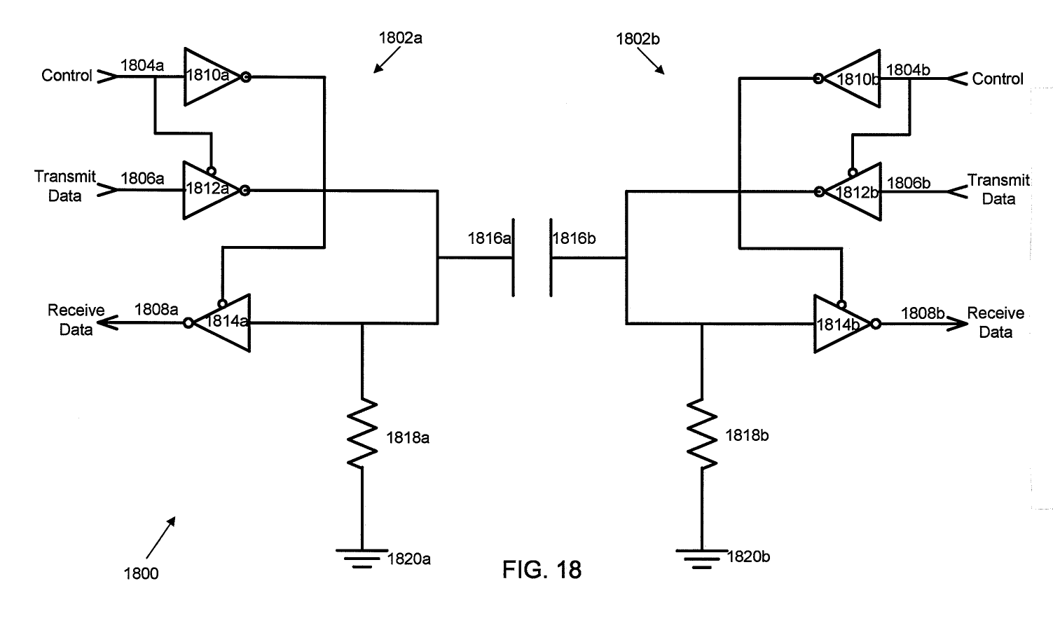

In one possible embodiment, the circuitry operates to transmit data at a 1200 bit per second rate, which is a widely available international data transmission standard. Using this transmission rate allows the systems described herein to transmit a kilobyte in roughly 6-7 seconds (including header information and any of various handshaking algorithms required), and allowing a 300 byte file to be transmitted in about two seconds or less. In certain embodiments, about 150 bytes of data are typically transferred at a time, allowing for about a single second of data transfer. Larger or smaller files require a proportional amount of time for data transmission. To allow larger files to be transferred in a shorter time, higher data transmission speeds can be implemented, such as 2400 bps, 4800 bps, 9600 bps, or the like, using full or half duplex modes of operation. An example of half duplex transmission circuitry is described below in conjunction with FIG. 18.

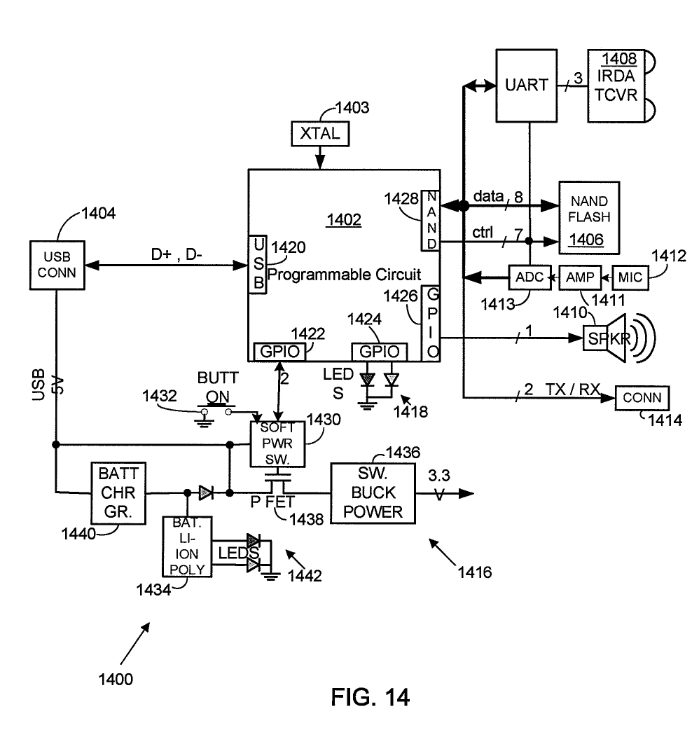

FIG. 14 illustrates a further specific embodiment of circuitry 1400 useable to implement aspects of the present disclosure. The circuitry 1400 can be implemented, for example, in the device 500 shown in FIGS. 5-7 or the other devices 800 and 1000 shown in FIGS. 8-11, as shown in the circuitry of FIGS. 12A and 12B. Alternately, and similar to the circuitry of FIG. 13, above, the circuitry 1400 can be implemented in a cellular telephone, personal digital assistant, or other handheld or portable electronics.

The circuitry 1400 generally includes a programmable circuit 1402, a USB connector 1404, nonvolatile memory 1406, infrared transceiver 1408, speaker 1410, receiver 1412, and a wired connector 1414. The circuitry also generally can include power circuitry 1416 and indicator LEDs 1418. Operation of these components is described in greater detail below.

The programmable circuit 1402 can be any of a number of different programmable logic devices or application-specific logic devices. In a possible embodiment, the programmable circuit 1402 is a programmable logic device, such as a field programmable gate array (FPGA), programmable logic array (PLA), or other similar device. The programmable circuit 1402 is configured to execute firmware instructions to execute various processes within the device. Although the specific processes may vary based on the specific nature of the device, the device will generally include functionality to allow access to the nonvolatile memory 1406 to the USB connector 1404, as well as to the various other input and output interfaces (e.g. the infrared transceiver 1408, speaker 1410, receiver 1412, and a wired connector 1414).

In the embodiment shown, the programmable circuit 1402 includes a variety of input/output ports, including a USB port 1420, three general purpose I/O ports 1422, 1424, 1426, respectively, and a memory access port 1428. Other ports may be included as well. The USB port 1420 is associated with the USB connector 1404, and provides a data connection from the programmable circuit 1402 to the USB connector. Likewise, general purpose port 1422 provides an interconnection to power circuitry 1416, port 1424 provides an interconnection to indicator LEDs 1418, and port 1426 provides a control interconnection to the other data connection interfaces (e.g. the infrared transceiver 1408, speaker 1410, receiver 1412, and a wired connector 1414). A crystal oscillator 1403 provides a clock signal to the programmable circuit 1402, and is also powered from the power circuitry 1416.

In certain embodiments, the programmable circuit 1402 executes firmware to allow only access to a portion of the nonvolatile memory 1406 to the various input and output interfaces that are not the USB connector interface.

The USB connector 1404 provides direct wired interconnection between the circuitry 1400 and a computing system to which the connector is connected. The USB connector 1404 provides a method by which data can be shared between the nonvolatile memory 1406 and the computing system, and can also provide a power connection to power the circuitry 1400 and recharge a power source integrated with the circuitry 1400. The nonvolatile memory 1406 can be any of a variety of types of nonvolatile memory, such as powered RAM, flash memory, or other memory types. In certain embodiments, the nonvolatile memory 1406 is a flash memory device interfaced to the programmable circuit 1402 by a data bus connecting between the memory and the memory access port 1428 of the programmable circuit 1402. In the embodiment shown, the memory access port is a NAND-configured memory access port configured to request and receive data from NAND type flash devices. In other embodiments, the port 1428 can be configured to access NOR-type flash devices.

The infrared transceiver 1408 provides full- or half-duplex data communication between the circuitry 1400 and an external device, such as another device incorporating such circuitry. An example of half-duplex data communication circuitry is described below in conjunction with FIG. 18. In the embodiment shown, the infrared transceiver operates at 4 Mbps in a half-duplex mode.

The speaker 1410 and receiver 1412 provide functionality for audible communication to the circuitry 1400, and also provide a method of indicating to a user that communication is taking place. For example, the speaker 1410 can be used to transmit audible signals that can contain audible data packets containing encoded digital data. The receiver 1412, conversely, can receive audible signals that contain audibly encoded digital data. Additionally, when the speaker 1410 and receiver 1412 are not used to transmit or receive data, they can be used by the circuitry 1400 to transmit information to the user by emitting sounds recognizable to the user (e.g. confirmation beeps, recorded messages, and other sounds). For example, the speaker can emit sounds corresponding to various data sharing tasks as they occur, such as powering on the data communications device, detecting another device, initiating data communication, confirming successful data communication, powering down, or other tasks.

In certain embodiments (such as the one shown), the receiver 1412 is a microphone interconnected to an amplifier 1411 and an analog-to-digital converter 1413, which act in combination to amplify sounds detected at the receiver and to sample those sounds for processing in the programmable circuit 1402. Other circuitry arrangements are possible as well.

The wired connector 1414 can provide a further method of communication between two similar devices (as in FIGS. 9A and 9B and FIGS. 11A and 11B, above) providing a direct electrical interface between two similar devices when connected in the proper orientation. In various embodiments, the wired connector 1414 can be a single pin serial connection, differential signal connection, or parallel connection configured to transfer data between two data communications devices.

The power circuitry 1416 includes a power switch 1430 interconnected to the general purpose port 1420. The power switch 1430 is activated by a button 1432 that allows the switch to activate, thereby completing a circuit for use with a battery 1434, an external power supply 1436 interconnected with the system, or through the USB connector 1404. A PFET switch 1438 allows selection of the battery 1434 and USB connector 1404 or the power supply 1436. The USB connector 1404 is further interfaced with a battery charger 1440 that can recharge the battery 1434 when the circuitry 1400 is interconnected with a computing system. Optionally, LEDs 1442 indicate the powered status (needs recharging, currently charging, charged, low power, etc.) of the battery 1434.

FIGS. 15-17 show exemplary data packets that can be communicated using the methods and systems described herein. FIG. 15 shows a first data packet 1500, which includes a number of start bits 1502, and a number of predetermined fields 1504a-e. The start bits can represent bits used by the system to determine the size and/or structure of the data packet, and can otherwise include other “header” information regarding the data packet and data file as a whole (which may be split among one or more data packets). The predetermined fields 1504a-e are shown to include a name 1504a, address 1504b, title 1504c, phone number 1504d, and email address 1504e, respectively, representing the typical information provided on a business card. Additional information can be included as well.

FIG. 16 shows a second data packet 1600 similar to the first data packet 1500 of FIG. 15, but including various alternate predetermined fields 1604a-d, including a name 1604a, address 1604b, phone number 1604c, and pointer 1604d. These data fields may be programmed by a user, or may represent various fields from, for example, an e-mail message selected for audible, optical, or wired transmission. The pointer 1604d can be used, for example in the network 450 of FIG. 4B, to access a media file or other type of file or message intended for the recipient of the pointer.

FIG. 17 shows a further data packet 1700 similar to the data packets of FIGS. 15-17, but includes customizable fields 1704a-c in combination with the start bits 1702. The customizable fields 1704a-c can vary in length or content, and depend upon the data selected for transmission using the systems described herein. The customizable fields 1704a-c may be defined using a tool provided on a personal computer connected to a handheld device, such as by using the electrical interface 1306 of FIG. 13. Additional methods of defining the customizable fields 1704a-c are possible as well. Further, more or fewer customizable fields can be incorporated into a data packet, and may be implemented in combination with predetermined fields such as those shown in FIGS. 15-16.

Referring now to FIGS. 15-17 generally, the start bits may or may not be present in any data packet, depending upon the particular implementation used for digital data transmission. Additionally, the start bits in any specific data packet may vary in number and content, based on the specific protocol used and data transmitted. Furthermore, the overall length of a given data packet may vary, depending on these or other factors.

Additionally, other types of information can be transmitted according to the principles of operation of the present disclosure, and the examples of FIGS. 15-17 are intended to be exemplary, and not limiting. Additional examples of data that may be transmitted according to the present disclosure include documents, text files, e-mail messages, multimedia files, and other digital data. Specific examples of such data can include video game information, such as configuration files or other shareable video game information. Further examples can include financial information, such as bank account or credit card information, including the number, expiration date, security code, or other information associated with an account. Other examples include personal information, such as a name, social security number, birth date, or other information. Additional types of information can be transmitted according to the present disclosure as well.

FIG. 18 illustrates interface circuitry 1800 for two communicating data communications devices, according to a possible embodiment of the present disclosure. The circuitry 1800 provides an example of a single pin, half-duplex interface useable for connecting two data communications devices 1802a-b, such as for use in a wired or optical data connection. The circuitry 1800 generally includes three signals per device a control signal 1804a-b, a transmit signal 1806a-b, and a receive data signal 1808a-b, with the signal corresponding to the data communications device with which it is associated. An inverter 1810a-b is connected to the control signal, and the inverse signals generated from the control signal 1804a-b are connected to tri-state buffers 1812a-b, 1814a-b connected to the transmit signals 1806a-b and receive signals 1808a-b, respectively. For example, in device 1802a, the control signal 1804a is connected to the tri-state buffer 1812a that buffers data from the transmit signal 1806a, while the inverse signal from the inverter 1810a provides a control connection to the buffer 1814a connected to the receive signal 1808a.

The output of tri-state buffers 1812a-b connected to transmit signals 1806a-b are joined to the input end of the tri-state buffers 1814a-b leading to receive signals 1808a-b, respectively, at a connector 1816a-b. The joining of the connectors 1816a and 1816b forms the connection between the two devices 1802a-b. Additionally, a resistor 1818a-b is connected between each connector 1816a-b, respectively, and a local ground 1820a-b. In certain embodiments, the resistors 1818a-b are each 100 kiloohm resistors.

In operation, one of the devices will be in a transmit mode, while the other device will be in a receive mode, or vice versa. The devices are placed in that mode by the programmable circuit or other portion of circuitry described in FIGS. 13-14, above, generating a control signal that will activate the transmit data buffer of that device. For example, if device 1802a is in a transmit mode and device 1802b is in a receive mode, a logic “1” control signal will be input on control signal 1804a while a logic “0” control signal will be input on control signal 1804b. In device 1802a, the logic “1” control signal will activate the tri-state buffer 1812a, and its inverse (logic “0”) output from the inverter 1810a will deactivate the tri-state buffer 1814a. Therefore, in device 1802a, data can be transmitted from the buffer 1812a, but cannot be received in the buffer 1814a. Conversely, device 1802b will output a logic “0” control signal, disabling the tri-state buffer 1812b connected to the transmit signal 1806b, while enabling the tri-state buffer 1814b connected to the receive signal 1808b, completing the connection between transmit signal 1806a and receive signal 1808b.

If device 1802b is communicating to device 1802a, oppositely configured control signals can reverse the flow of data passing between the devices. In certain embodiments, one or both devices may be placed by default in a logic “0” control state, enabling receipt of data but preventing output of data on the single pin connection. Other embodiments implementing different defaults or different numbers of contacts are possible as well.

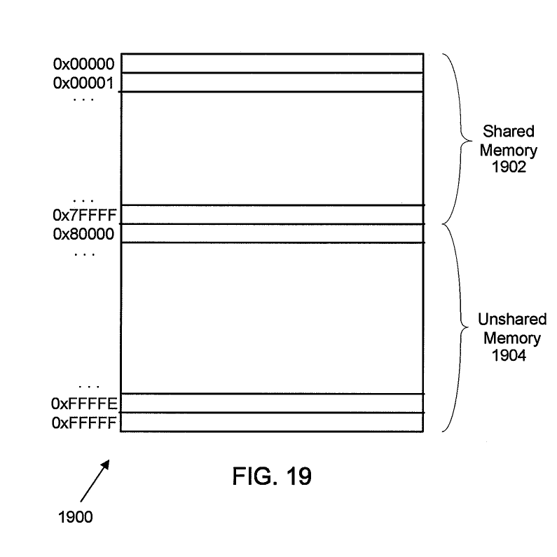

FIG. 19 illustrates a block of nonvolatile memory 1900 segmented into shared and private sectors, according to a possible embodiment of the present disclosure. The nonvolatile memory 1900, as shown, can be a byte-addressable portion of flash memory having 20-bit unique addresses, allowing for 2 GB of memory to be addressed. More or less memory can be incorporated in various other embodiments; the particular bit or byte addressing schemes and capacity of memory used is dictated in part by design choice of the nonvolatile memory and the capacity addressable by a selected programmable circuit interfacing with that memory.

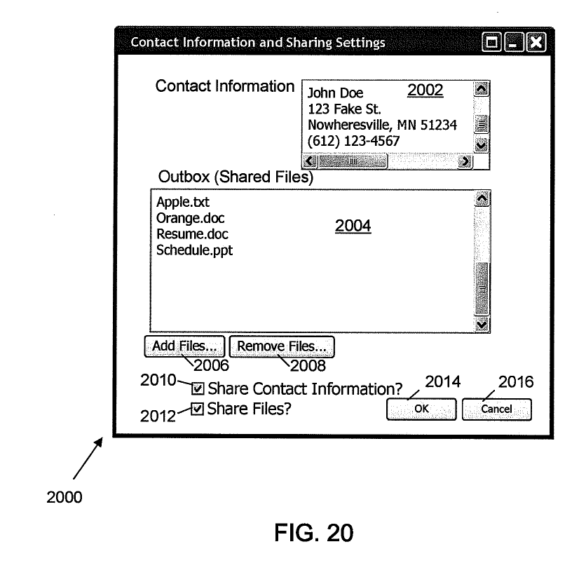

The nonvolatile memory 1900 is separated into two segments, shown as segments 1902 and 1904. The segments 1902 and 1904 can represent, in various embodiments, a public sector of memory and a private sector of memory, in which the public sector is fully accessible via all communications interfaces of a device, while the private sector is only accessible via a trusted, direct wired communication connection with the device (e.g. only through a USB connector interface). As shown in the figure, segments 1902 and 1904 are equal in size (each 1 GB in size), corresponding to equally-sized private and public memory sections for access by the various interfaces connecting to the data communications devices in which the memory is incorporated. Furthermore, the size and arrangement of the memory segments can be adjusted by a user of a data communications device through operation of its firmware. In one embodiment of the data communications device, the firmware includes instructions for transmitting instructions to a computing system upon connection thereto for generating a user interface, such as the user interface of FIG. 20, below. Such a system can allow a user of the device to adjust the sizes and arrangement of the sectors 1902, 1904 upon connection of the data communications device to a computing system.

Although in the present disclosure, two sectors 1902, 1904 are shown, additional sectors can be included in the memory, and can correspond to specific levels of security within the device. For example, one sector can be completely available via all communication interfaces of a data communications device, while another sector is only available to certain interfaces, while a third sector may only be available if proper user credentials are supplied. Additional criteria for access to the data in the memory 1900 may be implemented as well.

FIG. 20 illustrates an example user interface 2000 generated on a computing system for setting user information and file sharing information according to a possible embodiment of the present disclosure. The user interface 2000 allows a user of a data communications device, as described herein, to set information that will be shared with other data communications systems upon connection and initiation of a communications process as described in FIGS. 1-2 and FIG. 22, below. For example, the user interface 2000 can allow a user to enter business card information or other contact information, alongside media files, business card files, or other types of files or information that will be transferred between data communications devices.

The user interface 2000 includes a variety of fields that indicate the information that will be shared by the data communications device with another device to which it can connect. The fields include a user information field 2002, as well as a file listing field 2004 that operates in connection with an add files button 2006 and a remove files button 2008. The user information field 2002 allows the user to enter contact information relating to the user to allow exchange of personal “business card” type information about that user. The file listing field 2004 lists files that can be exchanged in conjunction with the personal information added into the user information field 2002. The add files button 2006 and remove files button 2008 allow the user to add or remove files from the file listing field 2004, respectively.

Check boxes 2010 and 2012 allow the user to select to transmit and share certain portions of the information selected using the user interface 2000. Check box 2010 allows the user to select to share the contact information entered into the user information field 2002. Check box 2012 allows the user to select to share the contact information entered into the file listing field 2004.

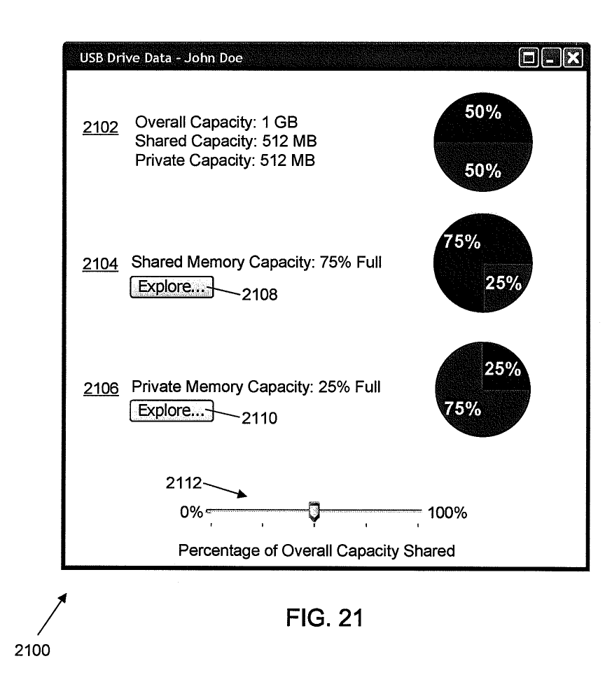

An OK button 2014 and a cancel button 2016, respectively, allow the user to either save the changes made to the user information entered into the user interface 2000 or cancel changes made in the user interface. In certain embodiments, one or both of these buttons allow the user to proceed to the user interface 2100 of FIG. 21, below. Furthermore, in various embodiments, other arrangements of the features disclosed in the user interface are possible as well, and additional features may be added.

Referring now to FIG. 21, an example user interface 2100 generated on a computing system interconnected with a data communications device is shown, according to the various embodiments of the present disclosure. The user interface 2100 allows a user to view and control the partitioning of memory for public and private data collections, as is allowed for in certain embodiments.

The user interface 2100 includes a plurality of indicators relating to the capacity of the data communications device (e.g. the USB flash drive device) and the capacity of the various sectors available in the device. In the embodiment shown, the user interface 2100 includes an overall capacity indicator 2102, as well as a shared sector capacity indicator 2104 and a private sector capacity indicator 2106. Additional or fewer sector capacity indicators are possible as well.

The overall capacity indicator 2102 displays the overall capacity of memory and percentage of memory allocated to the various sectors in the device. The shared sector capacity indicator 2104 displays the percentage of the shared memory sector (e.g. shared memory sector 1902 of FIG. 19, above) that is available and the percentage that contains data. Likewise, the private sector capacity indicator 2106 displays the percentage of the private memory sector (e.g. private memory sector 1904 of FIG. 19) that is available and the percentage that contains data. Each of the sector capacity indicators 2104, 2106 includes an explore button 2108, 2110, respectively. User selection (e.g. clicking with a mouse) of the explore button launches a file explorer window displaying the contents of memory in those sectors in a file and directory format known to those of skill in the art.

In certain embodiments, the explore button 2108 relating to the shared sector capacity indicator 2104 can allow a user to set specific data to be shared with other data communication devices. For example, the explore button 2108 can lead to the user interface 2000 of FIG. 20, described above. In certain further embodiments, the explore button 2108 can lead to an inbox or outbox configured to hold contact information and files received from other users (as well as that user's contact information and files) in a manner consistent with any of a variety of email client programs, such as Microsoft's Outlook email program or IBM's Lotus Notes email program. For various other sectors, different user interfaces may be used as well.

A slider bar 2112 allows the user to dynamically allocate more or less memory to the shared and private memory sectors, respectively, by allowing the user to slide the bar between “completely shared” and “completely private” positions. Additionally, the user can reallocate specific files as shared or unshared, or can alter the percentage of the memory that is shared or private, by dragging and dropping files between file explorer windows generated when pressing the explore buttons 2108, 2110, respectively.

Additional methods of allocating files to shared or unshared sectors of memory are possible as well. In certain embodiments, the files are designated as “shared” or “private” upon storage in the nonvolatile memory of the device by various rules. For example, files stored in the memory that are received via the USB connection to a computing system would be noted as “private” while files received via other communication connections (audible, optical, or wired) could be noted as “public”. A user viewing, for example, a file explorer window could change the designation of the file between “public” and “private”, indicating that the file will or will not be shared upon connection of the device to either another device (e.g. for “public” files) or to a computing system connected to by the USB connector (e.g. for both “public” and “private” files). Further methods or systems are possible as well. One possible method of transmitting shared or unshared files is disclosed in the method of FIG. 21, described below.

In certain embodiments, the various sectors of the memory that are explored contain databases for receiving information from other devices, and from computing systems interconnected with such devices. In further embodiments, the files can be stored in the native format of the files.

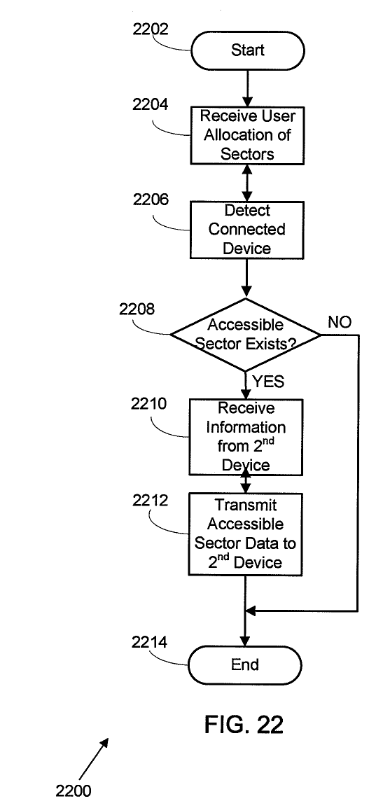

FIG. 22 illustrates a flowchart of methods and systems for sharing data in a sector of memory of the various data communications devices of the present disclosure. The methods and systems 2200 shown provide a process by which data from a particular sector can be shared with corresponding data communications device. For example, the data shared in certain sectors of a device can be exchanged when another such device, which is designated to receive that data, is detected. The system 2200 is instantiated at a start operation 2202. Operational flow proceeds from the start operation to a sector allocation module 2204. The sector allocation module 2204 corresponds to receiving user allocation of memory in the data communications device relating to sharing of data among devices according to the various interfaces available. For example, the sector allocation module 2204 can correspond to receipt of instructions from a user via the user interface of FIG. 21, above. Other methods of receipt of sector allocation instructions are possible as well.

Operational flow proceeds to a device detection module 2206. The device detection operation corresponds to detection of another device interconnected with the data communications device, such as is shown in FIGS. 4, 9A-9B, and 11A-11B. The device detection module 2206 verifies that another device is present, such as by sending out a test data message or otherwise attempting a handshaking operation and receiving confirmation from the second device that the handshaking or other connection confirmation is successful. In certain embodiments, the device detection module is initiated by pressing a soft key on one or more of the data communications devices, according to the various embodiments described herein.

Operational flow proceeds to a sector validation operation 2208. The sector validation operation 2208 determines whether a sector exists that is accessible to a second device, and whether any data exists in that sector for exchange with an interconnected device. In a possible embodiment, the sector validation operation 2208 corresponds to determining the existence of a public sector and optionally also determining that some contents are stored in that sector or memory for exchange. If an accessible sector exists, operational flow branches “yes” to a data receipt module 2210, operation of which is described below. If no accessible sector exists, operational flow branches “no” to an end operation 2214, which corresponds with a completed (and in this case, failed) attempt to exchange data between data communications devices.

The data receipt module 2210 corresponds generally to the methods and systems for receiving data in a data communications device, such as are described above in conjunction with FIG. 1. However, it is understood that the data receipt module 2210 generally limits the data received to data from the second device that is in an accessible sector of that device (e.g. the data that is designated using firmware such as is described in FIG. 20, above), and is also limited by the available non-occupied space allocated to the determined-to-be accessible sector of the receiving device.

Operational flow proceeds from the data receipt module 2210 to a data transmit module 2212. The data transmit module 2212 generally corresponds to methods and systems for transmitting data, as are described above in conjunction with FIG. 2. However, as with the data receipt module 2210, it is understood that the data transferred is generally limited to the data (e.g. the non-duplicate data or predesignated files and contact information) stored in the accessible sector, as determined in the sector validation operation 2208.

Through use of the data receipt module 2210 and data transmit module 2212 it can be seen that two interconnected data communications devices can exchange data that is stored in mutually accessible sectors of memory within those corresponding devices. This “shared” data can easily be passed among a variety of such data communications devices, either in a one-file-at-a-time or a full memory exchange manner.

Operational flow proceeds from the data transmit module 2212 to the end operation 2214, which in this case corresponds to successful linking and exchange/synchronization of data between data communications devices.

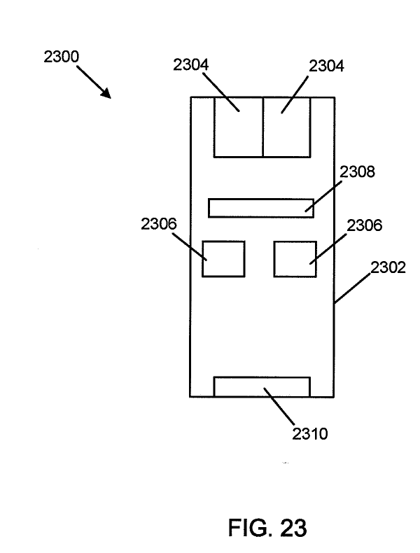

Referring now to FIGS. 23-33 a number of additional features integrable into and useable with the data communications device of the present disclosure are described. FIGS. 23-25 describe certain optional additional embodiments of the data communications device. The embodiments of the data communications device shown in these Figures are useable in a variety of contexts, and include a variety of features for overcoming issues related to power, bandwidth, and interference issues.

FIG. 23 is a block diagram representation of a data communications device 2300 according to a possible embodiment of the present disclosure. In certain embodiments, the data communications device 2300 is a low-cost, handheld computing device, such as a USB flash drive sized device. In one embodiment, the data communications device 2300 includes a body section 2302, a plurality of communication apertures 2304, a plurality of actuable switches or buttons 2306, a first surface 2308, and a first aperture 2310. In certain embodiments, the body section 2302 is a molded plastic form having a plurality of ergonomic features to facilitate attendee handling. In general, body section 2302 serves to contain a plurality of functional electronic circuitry within an enclosed internal section (not shown).

In certain embodiments, the communication apertures 2304 are defined as a wireless communication port and a USB port. In a preferred embodiment, the wireless communication port is an infrared communications port. However, other types of wireless communications ports can be used as well. For example, the wireless communication port can be, in various embodiments, an audible communication port, a radio frequency communication port, or other wireless communication port capable of communicating via other protocols/media. Further, in general, the USB port can be any type of USB port. For example, the USB can be a Standard-A connection, a Standard-B connection, a Mini-B connection or other types of USB connections. In a preferred embodiment, the USB port is a Mini-B USB connection.

In certain embodiments, the plurality of actuable switches 2306 can for example include an on/off switch, a mode switch, a download request switch, and/or others. In one embodiment, switches 2306 can be any type of binary switch such as a rocker switch, a pushbutton, and/or any combination of other types of switches such as dials and the like. For example, in one possible embodiment the data communications device 2300 can be configured operate in a mode that requires a command, such as depressing a respective switch 2306, to exchange information with a compatibly configured computing device. Alternatively, the data communications device 2300 can be configured to operate in a mode that functions as a “listening mode” by depressing a respective switch 2306 such that the data communications device 2300 periodically “sniffs” for a communications signal.

As described above, in certain embodiments the body section 2302 can include a first surface 2308 and an aperture 2310. In one embodiment, the first surface 2308 is an ink friendly signature line for labeling with a writing utensil such as a pen or a marker. Further, in certain embodiments aperture 2310 can be formed such that a lanyard can be inserted therethrough. In this manner, the data communications device 2300 can be easily secured and/or transported as desired.

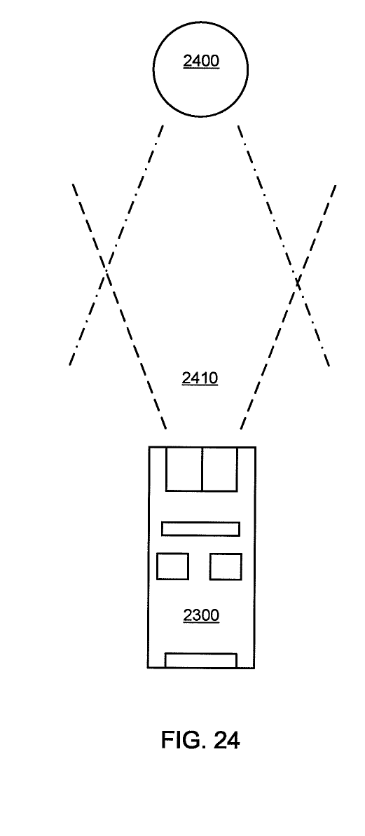

FIG. 24 is a schematic diagram of directional wireless data transfer, useable to implement aspects of the present disclosure. The schematic diagram illustrates communication between a data communications device (e.g. data communications device 2300) and a corresponding device 2400 capable of communicating with the data communications device.

In the embodiment shown, the data communications device is illustrated as the device 2300 described in conjunction with FIG. 23; however, any of the previously-described data communications devices can operate according to analogous principles, and therefore could be used as well.

The device 2400 can be any of a number of wireless communications devices capable of communicating with a data communications device, by using the same media (e.g. audible, radio frequency, or infrared signals) and an understandable protocol for communication. In certain embodiments, the device 2400 can represent another data communications device, such as another data communications device 2300.

In the embodiment shown, the device 2300 is arranged to include an aperture which allows the device to communicate in a generally directional manner, such that the general direction of communications signals sent by the device can be controlled by a user pointing the data communications device 2300 at a desired target device. The aperture defines a generally directional output region 2410 for output of wireless signals. In one embodiment, the directional output region 2410 is arranged to direct audio signals from the data communications device 2300 to the exchanging device 2400 in an environment where audio interference may be possible, such as in a crowded or noisy room. In such embodiments, the data communications device 2300 can also be configured to automatically seek an appropriate audio level (e.g. by increasing audio intensity until successful transmission (e.g. as indicated by received acknowledgement by the corresponding device 2400).

The device 2400 can, in certain embodiments, have a corresponding aperture to provide directional wireless communication in a manner corresponding to the aperture discussed in conjunction with the data communications device. Furthermore, although described in conjunction with audible transmission, the aperture and directional output of the data communications device can be used in conjunction with transmission media other than audible signals (e.g. infrared or radio frequency signals).

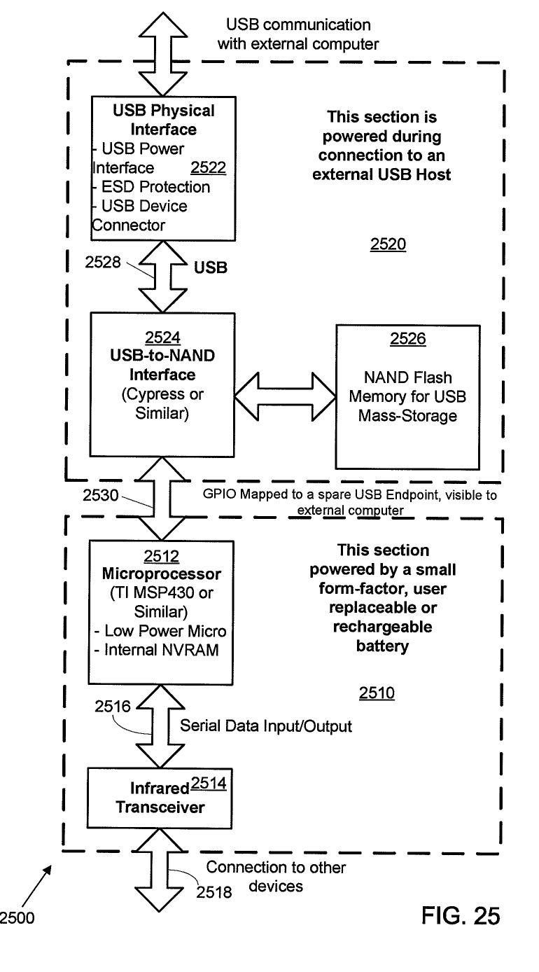

FIG. 25 is a schematic block diagram of portions of a data communications device 2500 according to a further possible embodiment of the present disclosure. The data communications device 2500 represents a further possible embodiment of the device previously described, and introduces certain additional features that can provide power savings for data communications.

Generally the communications device 2500 includes a powered region 2510 and an unpowered region 2520. The powered region 2510 is configured to operate in the absence of a connection to a personal computing device. The unpowered region 2520 includes circuitry components configured to operate only in the presence of a connection to a personal computing device. In the absence of a connection to an external personal computing device that can provide power to the unpowered region 2520, that region remains inactive and does not drain battery power from the powered region 2510.

The powered region 2510 includes a programmable circuit 2512 and a transceiver 2514, interconnected at a transceiver interface 2516. The programmable circuit 2512 provides data processing and controls data communications through the transceiver 2514. The programmable circuit 2512, shown as a microprocessor, includes a generally low power consumption and low capacity memory, such as an internal NVRAM memory. The memory in the programmable circuit 2512 can store certain firmware programs for controlling and configuring operation of the data communications device 2500, and can store user information, such as files or links to files, for access and review when the data communications device 2500 is connected to a computing device. The transceiver 2514 provides an interface for communication with other data communications devices. From the transceiver 2514, a wireless communication link 2518 can be established to another device, such as another data communications device 2500, using the communications media and protocols described herein. The transceiver interface 2516 can be any of a number of serial or parallel data interfaces capable of communicatively connecting the programmable circuit 2512 and transceiver 2514.

A power source (not shown) such as a battery or other portable power supply is provided and connected to the components of the powered region 2510. The power source provides electrical energy for operation of the items in the powered region 2510 when the device 2500 is not connected to a computing system. In certain embodiments, the power source can be user-replaceable, or rechargeable through a connection to a computing system (e.g. via the powered connection to the computing system included in the unpowered region 2520.

The unpowered region 2520 includes a physical interface 2522 interconnected to a memory interface 2524 and flash memory 2526. The physical interface 2522 provides data configuration and buffering necessary to communicate via a wired communications protocol (e.g. via a USB connection) with a computing system. The memory interface 2524 provides memory control and coordination of data transmission to both the flash memory 2526 and the programmable circuit 2512. The flash memory 2526 is generally a large-capacity memory configured to store files received either via the transceiver 2514 (e.g. wirelessly from another data communications device) or the physical interface 2522 (from a computing system).

The physical interface 2522 is connected to the memory interface 2524 by a powered link 2528, allowing distribution of power to the memory interface 2524 and the flash memory 2526. The powered region 2510 and unpowered region 2520 are connected by a general purpose input/output link 2530, which provides a data and electrical connection between the regions.

In general, the device 2500 is configured such that when the device is not connected to a computing system, the powered region 2510 can remain active to exchange files or links to files between devices. When the device is connected to a computing system, both the powered region 2510 and the unpowered region 2520 are active. In such an arrangement files are made accessible to the computing system that are stored both in the flash memory 2526 and the memory within the programmable circuit 2512.

Optionally, the programmable circuit 2512 can be configured to periodically transmit data from its internal memory (e.g. NVRAM) to the flash memory, preferably when the data communications device 2500 is connected to a computing system. In this way, the NVRAM of the programmable circuit can then be cleared, allowing additional storage of files or links to files in that limited memory space, and performing writes to flash memory 2526, which are relatively high-power-consumption operations, at a time when power is made available to the device 2500 from the computing system.

It can be seen that, through use of the separated powered and unpowered regions 2510, 2520, only a portion of the data communications device 2500 might be used when the device is not connected to a computing system to provide electrical power to the device. By including low power components for use in the powered region 2510 and higher-powered components in the unpowered region 2520, an extended battery life can be accomplished in the device 2500, by eliminating the power draw of large memories and controllers (e.g. the flash memory 2526 and controller 2524).

Although the data communications device 2500 is described as having certain components included, it is understood that additional components may be incorporated based on the choice of media by which the device communicates, the specific feedback mechanisms to be used by the device, and other features previously described.

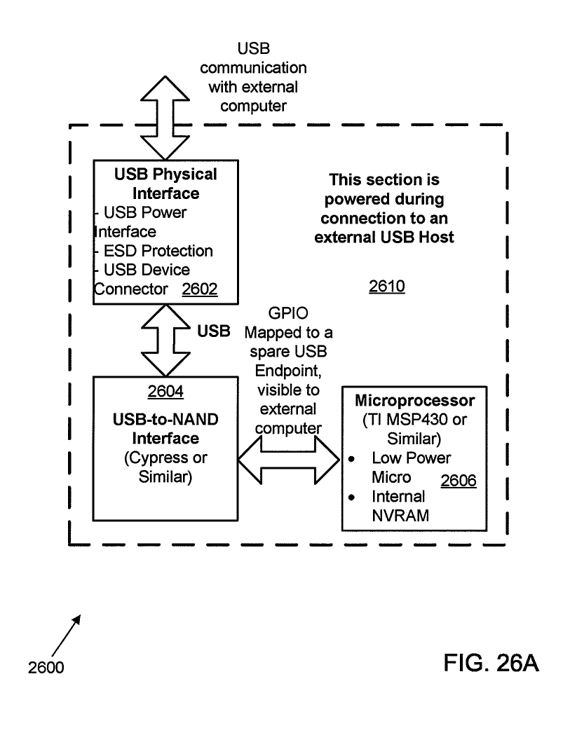

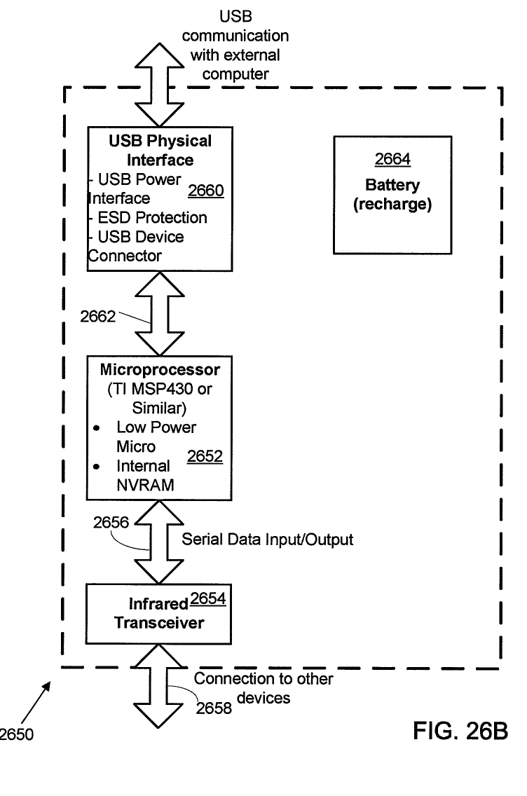

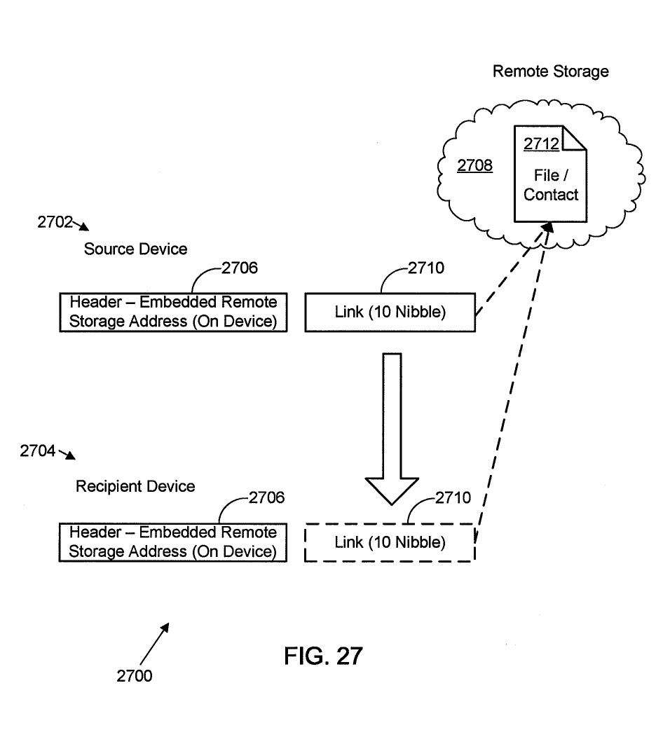

FIGS. 26A-B are schematic block diagram of portions of a data communications device according to further possible embodiments of the present disclosure. Referring to FIG. 26A, the data communications device 2600 generally corresponds to the device 2500 of FIG. 25; however, in the embodiment shown, only an unpowered region 2610 exists within the device. Therefore, the data communications device is only operable while in connection with an external computing system via a powered (e.g. USB) interface. As illustrated, the device 2600 includes a USB interface 2602, a USB-to-NAND interface 2604, and a programmable circuit 2606 which includes a memory. Each of these components provides analogous functionality to the like components of FIG. 25. In this embodiment, the data communications device 2600 operates analogously to a typical USB-flash drive device, but, rather than storing data in a flash memory, uses a link system (e.g. the link system described below in conjunction with FIGS. 27-31) to access files. The device 2600 therefore represents a cost-reduced version of the device 2500, which does not provide for direct device-to-device communication.

The data communications device 2650 of FIG. 26B generally corresponds to the device described in FIG. 25; however, device 2650 does not include a flash memory or related flash memory controller, thereby providing additional power and cost savings by managing links to files in a smaller-capacity, lower-power memory. The device 2650 includes a programmable circuit, illustrated as a microprocessor 2652, including the memory used by the device, such as an NVRAM. The programmable circuit 2652 is linked to a wireless transceiver 2654 by a serial connection 2656. The wireless transceiver 2654 allows the device 2650 to establish a wireless link 2658 to another device for file/link transfer. The programmable circuit 2656 is further connected to a USB interface 2660 via an electrical connection 2662. A battery 2664 provides power to the device when not connected to a computing system, and can, in various embodiments, be a rechargeable and/or user-replaceable battery.

FIG. 27 is a diagram of a file transfer operation 2700 useable to implement certain aspects of the present disclosure. The file transfer operation 2700 depicts a situation in which a link to a file is sent from a source device 2702 to a recipient device 2704. At least one of the source device 2702 and recipient device 2704 generally corresponds to a data communications device according to one of the embodiments disclosed herein. In certain embodiments, that device corresponds to one of the low-power consumption devices described in conjunction with FIGS. 25-26.

In the file transfer operation shown, both the source device 2702 and the recipient devices 2704 are pre-programmed with a header 2706, which provides an embedded remote storage address. The remote storage address provides the location of a remote storage 2708, which can, in various embodiments, correspond to a remote server configured to manage files transferred between data communications devices. The header 2706 can, in various embodiments, define a website link or other networked address.

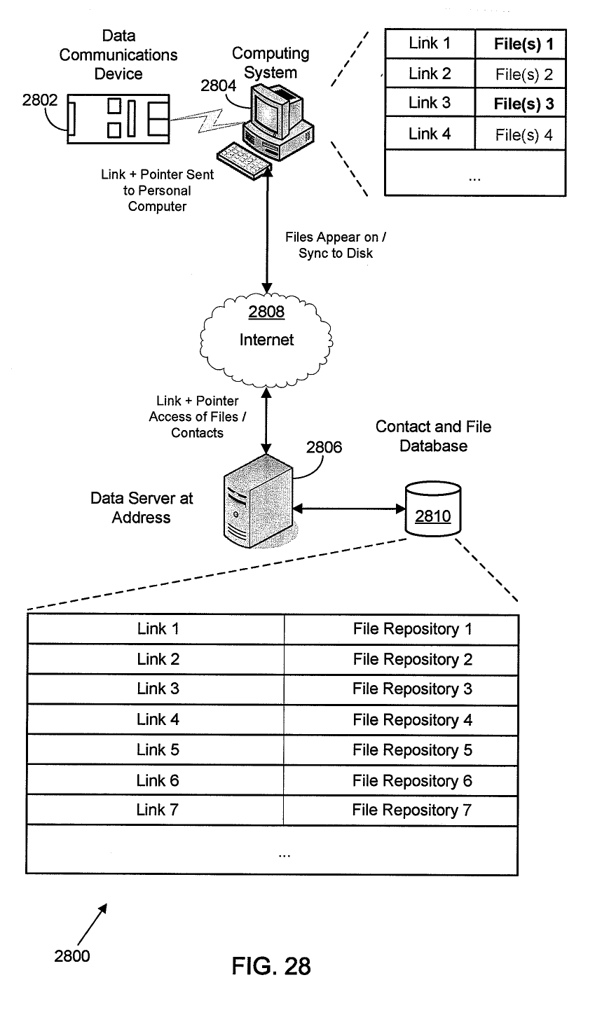

The source device 2702, when actuated, transmits a link 2710 to the recipient device 2704. The link 2710 provides a reference to a file 2712 stored at the remote storage 2708. After transmission of the link, either device can access the file by using an address combination of the header 2706 and link 2710, as illustrated in FIGS. 28-31, below.

In various embodiments of the present disclosure, the link 2710 can take any of a number of forms. In one particular embodiment, the link 2710 is a 5-byte (10-nibble) long hexadecimal string, which provides for over a trillion unique pointer references to files stored at the remote storage 2708. However, the link 2710 can be of other longer or shorter lengths, depending upon the number of unique link identifiers required.

In one particular embodiment of the operation 2700 where transmission of the link 2710 from the source device 2702 to the recipient device 2704 occurs via an audible signal, the transfer of the link can be embodied as a dual-tone multi-frequency (DTMF) signal. The DTMF signals can be transferred between the source device 2702 and the recipient device 2704 as fast as about 5-20 milliseconds per tone, thereby causing an overall communication session to require less than about 200 milliseconds. The DTMF signal, commonly used for telephone line data signaling, can be used to provide a robust audible signal for data communications.

FIG. 28 is a schematic block diagram of a network 2800 in which a data communications device can be used, according to a possible embodiment of the present disclosure. The network 2800 illustrates a possible arrangement in which the file transfer operation 2700 of FIG. 27 can take place, according to aspects of the present disclosure. The network 2800, as shown, corresponds to an instance in which one of a plurality of data communications devices 2802, which can be any of a number of types of data communications devices disclosed herein, is connected to a computing system 2804 that can communicate with a remote, networked server 2806 via the internet 2808. The server 2806 hosts a database 2810 which contains files and other data commonly used by users, and linked to by links assigned by software resident on the server 2806 and communicated to the computing system 2804.

In use, the database 2810 generally stores a copy of information that is intended to be communicated between data communications devices. When a file is to be stored on a data communications device from a computing system, a copy of that file is transmitted to the server 2806, which in turn generates a link to be returned to the computing system and stored on the communications device 2802. In embodiments of the data communications device 2802 that include a high capacity flash memory and a low capacity memory, the link can be stored in one or both of the memories, and the file can be stored in the flash memory. In embodiments containing only a low-capacity memory (e.g. NVRAM of the data communications devices of FIGS. 25-26), it may be preferable to store only link information on the data communications device.

A user of a data communications device may desire to either transfer the link to a different data communications device, or to use a different computing system from the one that has the linked file stored thereon. In such a case, once a new device or computing system is used and the file is desired by the user, firmware on the device (and/or software downloadable from the site identified in the header) causes uploading of the links from that device to a computing system (e.g. computing system 2802), which sends those links as a data request to the server 2806 identified by the header. The server performs a lookup operation, and provides the files identified by the links to the computing system 2804. In this way, storage of data files on the data communications device itself is optional, and large data transfers between data communications devices can be avoided (e.g. because both devices merely transmit a link to a remote location holding the larger file). Storage of full files on a device can generally be performed for caching purposes, and can be stored/removed based on a policy set on the device (e.g. a least recently used basis).

In the embodiment shown, the data communications device 2802 has stored thereon four links, illustrated as Link 1, Link 2, Link 3, and Link 4. When the data communications devices 2802 is connected to the computing system 2804, firmware residing on the data communications device is instantiated, and provides link and header information to the computing device. The computing device in turn transmits a data request to the server 2806 for the information that is stored in the database 2810 at the links. The server provides information corresponding to those links from its database containing links to all files (e.g. Link 1 through Link 7, et al.) managed for the data communications devices 2802 in the network.

In certain embodiments of the network 2800, file access requests are all sent to the server 2806 upon connection of the data communications device 2802 to the computing system 2804, thereby allowing the computing system to cache the returned files for local access. In further embodiments, only basic file information is requested from the server 2806 upon connection of the data communications device, and files are requested from the server 2806 on an as-requested basis, as a user selects one or more of the files for opening, editing, etc. In the embodiment shown, the bolded files correspond to files accessed by a user, and therefore files for which local cached copies exist on the computing device 2804.

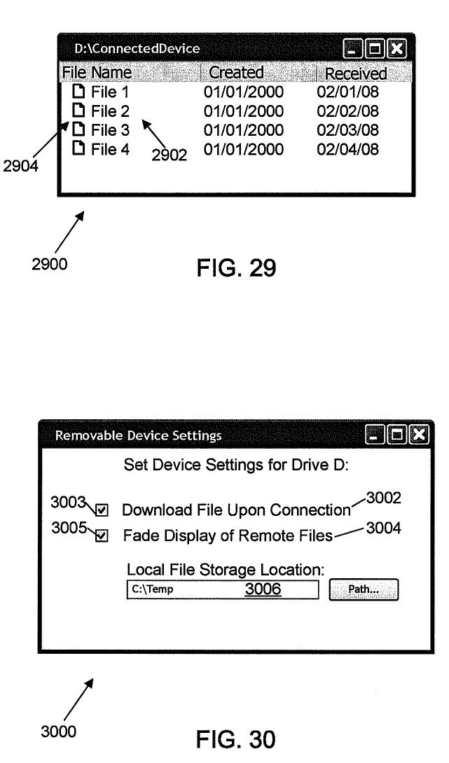

FIG. 29 shows an example user interface 2900 displaying files accessed using a data communications device within the network 2800 of FIG. 28, according to a possible embodiment of the present disclosure. The user interface 2900 provides a graphical tool to a user for selecting, viewing, and editing files corresponding to the links stored on a data communications device of the present disclosure. The user interface 2900 generally appears as a file explorer window, and includes file names 2902 and icons 2904 as commonly known in the art. The user interface 2900 allows a user to view files as though the files are stored locally on a computing system 2804 or a removable data communications device 2802. In fact, the files may be stored in any of a number of locations, such as a high capacity memory (e.g. flash) of the data communications device 2802, local memory cache on the computing system 2804, or remotely in the database 2810 of the server 2806. The basic file information is, as previously discussed, retrieved by the local computing system 2804 from any location containing the file (e.g. at the device, computing system, or server) while allowing the file itself to remain in its prior location. Upon a request from a user via the user interface 2900 to open the file (e.g. by double-clicking on a file name 2902 or icon 2904) will the file be downloaded for local storage (temporary or permanent).

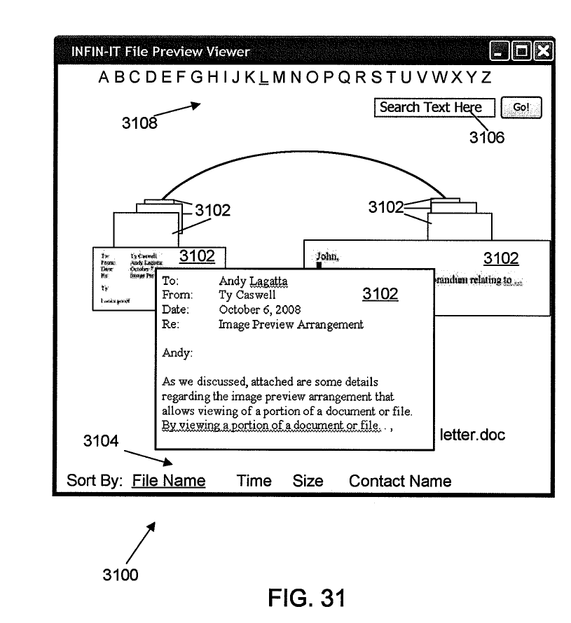

FIG. 30 shows an example user interface 3000 displaying user settings selectable with respect to data access from a data communications device, according to a possible embodiment of the present disclosure. The user interface 3000 provides options for allowing a user to select a manner in which data coordination is performed within the network 2800 of FIG. 28. The user interface 3000 can be generated based on software local to a computing system (e.g. a computing system 2804) or resident in firmware of a data communications device (e.g. device 2802).

The user interface 3000 includes a download option 3002, a display option 3004, and a local file storage field 3006. By selecting a checkbox 3003, the download option 3002 allows a user to select to download full copies of all files from a remote server database (e.g. database 2810 of server 2806) upon initial connection of a data communications device to a computing system. If the checkbox 3003 is not selected, remote files are not fully retrieved until specifically opened or otherwise accessed by a user, e.g. via the user interface 2900 of FIG. 29 (or interface 3100 of FIG. 31, below).

By selecting a checkbox 3005, the display option 3004 allows a user to distinguish local, downloaded files from remote files. If the checkbox 3005 is selected, filenames or icons related to remotely-stored file are faded or otherwise distinguished from the locally stored files in the user interface 2900 of FIG. 29 (or in interface 3100 of FIG. 31, below). If the checkbox 3005 is not selected, no distinction is made between the appearance of filenames or icons, regardless of the storage location of the corresponding files.

By designating a particular path in the local file storage field 3006, the user can designate a folder for caching local copies of files on the computing system. These files can be persisted on the computing system even if no network connection to the server 2806 referenced by the header on the communications device is available.

FIG. 31 shows a further example user interface 3100 displaying files accessible using the data communications device and a computing system, according to a possible embodiment of the present disclosure. In certain embodiments, the user interface 3100 is accessed via launching of a browser module, such as can be included within the firmware of a data communications device or loaded onto a computing system. In one example embodiment, files 3102, such as vCard information, text files, media files, or other types of information, are graphically rendered on user interface 3100 as image versions of the underlying information. In certain embodiments, the files linked to by the data communications device are graphically rendered on user interface 3100 in a circular format to represent a “rolodex” type format. For example, in certain embodiments, a plurality of files 3102 are stored alphabetically according to predefined criteria (i.e., filename, time, size, or contact name associated with the file), selectable via a set of links 3104 presented on the user interface 3100. In certain embodiments, the “rolodex” as rendered on user interface 3100 is cyclically accessible such that respective files rotate to centrally present a specific file 3102 as desired. In certain embodiments, a respective file 3102 can be selected to open and edit as desired.

In certain embodiments, a search data field 3106 is provided such that a user can keyword search through available files. Additionally, an index 3108 can be provided to quickly cycle a user to a certain area of the user interface to find a specific file, as desired. Although in the embodiment shown the index 3108 is alphabetical, the index may vary based on the method in which the files are arranged (i.e. as selected in the set of links 3104).

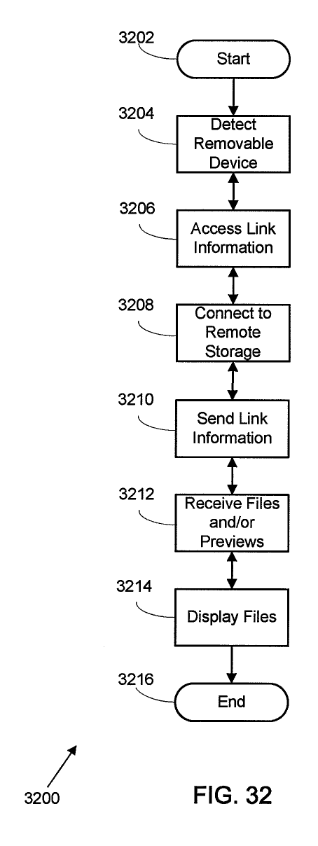

FIG. 32 is a flowchart illustrating methods and systems for data access and synchronization. The methods and systems disclosed in the flowchart are generally useable to provide synchronization of data between a remote database and a local computing device communicatively connected to a data communications device, allowing either simulated local storage of files or local synchronization of files with the remote database. In use, the methods and systems of FIG. 32 can be used within the network 2800 of FIG. 28, in which a remotes database provides a central data repository for literature, contacts, and other files referenced on the data communications device.

The system 3200 of FIG. 32 is instantiated at a start operation 3202, which corresponds to initial connection of a data communications device to a computing system communicatively connectable to a remote database. Operational flow proceeds to a detection module 3204, which corresponds to the computing system detecting the connection with the data communications device (e.g. a USB or other detectable communications connection).

Operational flow proceeds to an access module 3206, which corresponds to access of link information and header information stored on a data communications device. Operational flow proceeds to a connection module 3208 which establishes a communicative connection between the data communication device and the computing system. In certain embodiments, the access module 3206 further corresponds to initial execution of firmware and/or software instructions on the data communications device or computing system to allow browsing of the files linked to via the data communications device.

Operational flow proceeds to a send module 3210, which corresponds to sending link information to the server identified by the header information retrieved from the data communications device. The send module sends each link to the server to retrieve at least file information (i.e. filenames, file attributes, file sizes, etc.) about the files referenced by the links. In certain embodiments, the send module 3210 further corresponds to transmission of the link and header information to a server to request in response a copy of each file referenced by the link information.

Operational flow proceeds to a receipt module 3212. The receipt module 3212 corresponds to receipt of information requested in the send module 3210. In embodiments in which only file information is requested, a set of information about the files is returned, with each file being referenced by one of the links stored on the data communications device. In embodiments in which the entire file is requested, a set of files can be returned to the computing system associated with the data communications device.

Operational flow proceeds to a display module 3214, which corresponds to display of a file listing to a user. For example, the display module 3214 can correspond, in various embodiments, to display of a user interface for browsing the various files linked to by the data communications device. Example user interfaces generated by the display module can include, for example, those shown in FIGS. 29 and 31, respectively. The display module 3214 can also include display of at least a portion of the contents of a file, such as by display of an image generated from at least a portion of the file, as illustrated in FIG. 31, above.

Operational flow proceeds to an end module 3216, which corresponds to completed access to data referenced by the data communications device.

Referring now to FIG. 32 generally, it is noted that the operation of the various modules can be interchanged, can performed in a different order, or concurrently. For example, a user can access one or more files, have a portion of that file displayed, but then request to view another one or more files from the same collection of files on a data communications device. In such an instance, repeated, or different aspects of the send module 3210, receipt module 3212, and display module 3214 may be used.

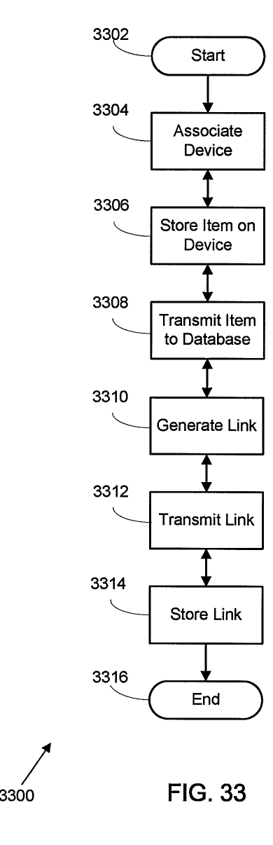

Referring now to FIG. 33, a flowchart is shown of methods and systems for uploading data to a remote database for association with a data communications device, according to an aspect of the present disclosure.

Operational flow within the system 3300 is instantiated at a start operation 3302, which corresponds with connection of a device to a computing system within a network, such as the network of FIG. 28, above. Operational flow proceeds to an association module 3304, which corresponds to associating a data communications device with the computing system, such as by recognizing the data communications device and initializing operation of software or firmware on the device or computing system that facilitates file management with the device.

Operational flow proceeds to a store module 3306, which corresponds to a user selecting a file and storing the file on the data communications device. This can include, for example, a cut/paste or drag/drop action, or a menu operation within software enabled by the association module 3304. In certain embodiments in which the device includes a mass storage, all or a portion of the device is optionally stored on the device; however, such storage is not necessary to effect the data access principles of the present disclosure.

Operational flow proceeds to a transmit module 3308, which corresponds to transmission of the file from the computing system to a remote server designated by a header read from the data communications device, the remote server hosting a database of files to be shared among data communications devices. A generate link module 3310 generates a unique link identifier related to the file to be stored. As previously indicated, this can be a 5 byte hexadecimal number capable of identifying the associated file; however, other types of links can be used as well.

A transmit link module 3312 transmits the link from the server to the computing device, and a store link module 3314 causes the link to be stored on the server in association with the file, as well as on the data communications device, preferably in the absence of the associated file. An end operation 3316 completes the system 3300 for storing items in conjunction with a data communications device.

Referring now to FIGS. 23-33 generally, it can be seen that a number of advantages are provided by way of the data communications devices, methods, and systems described. For example, using the systems and methods disclosed herein, a low-power, relatively small-capacity memory device can be used in a device having one or more data communications interfaces. Such devices can use remote storage and coordination of files to provide near-realtime simulated local storage of files based on linking and low-power small data packet transfers.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A data communications device comprising:
A handheld-sized housing containing circuitry including a powered region and an unpowered region;
the powered region configured to be operable in the absence of a connection to a computing system, the powered region including a programmable circuit and a wireless transceiver, the programmable circuit connected to the wireless transceiver for wirelessly exchanging files with another data communications device, the programmable circuit including a memory; and
the unpowered region configured to be inoperable in the absence of a connection to a computing system, the unpowered region including a USB interface and a flash memory;
wherein the unpowered region is communicatively connected to the powered region.

2. The data communications device of claim 1, wherein the USB interface is configured to transmit power to the powered region when the data communications device is connected to a computing system via the USB interface.

3. The data communications device of claim 1, wherein the memory included in the programmable circuit is an NVRAM memory.

4. The data communications device of claim 1, wherein the programmable circuit is configured to, upon detecting that the USB interface is connected to a computing system, store data in the memory included in the programmable circuit into the flash memory.

5. The data communications device of claim 1, wherein the transceiver is an infrared transceiver.

6. The data communications device of claim 1, further comprising a feedback device configured to provide feedback to a user to signify successful wireless transmission of data from the wireless transceiver.

7. The data communications device of claim 6, wherein the feedback device includes a vibrating mechanism.

8. The data communications device of claim 1, wherein the wireless transceiver outputs data through an aperture arranged to directionally transmit data.

9. The data communications device of claim 8, wherein the programmable circuit is configured to actuate the wireless transceiver at a plurality of intensities.

10. The data communications device of claim 9, wherein the programmable circuit is configured to actuate the wireless transceiver at increasing intensities upon a determination of failed transmission of the data.

11. A method of storing data associated with a data communications device, the method comprising:
connecting a data communications device to a computing system via a USB interface;
transmitting data selected for storage on the data communications device to a server remote from the computing system and identified by a header stored on the data communications device;
receiving a link generated by the server that uniquely identifies the data transmitted to the server; and
storing the link in a memory of the data communications device.

12. The method of claim 11, further comprising transmitting the link to a second data communications device via a wireless interface of the data communications device.

13. The method of claim 12, wherein transmitting the link is accomplished via DTMF encoding of the link.

14. The method of claim 12, further comprising accessing the data on the server using the second data communications device.

15. A method of accessing data stored on a server and identified by a data communications device, the method comprising:
connecting a data communications device to a computing system via a USE interface;
transmitting links stored on the data communications device to a server identified by header data stored on the data communications device;
accessing identifying information about files associated with the links; and
displaying a user interface to a user, the user interface presenting the identifying information such that the files appear to be stored on the data communications device.

16. The method of claim 15, wherein the identifying information includes a filename and icon relating to each the files.

17. The method of claim 15, wherein the user interface is displayed on the computing system.

18. The method of claim 15, wherein the links include a plurality of hexadecimal digits corresponding to DTMF tones.

19. The method of claim 15, wherein the server hosts a database of all files available to data communications devices having the header stored thereon.

20. A computer-storage medium for storing computer instructions capable of generating a user interface on a computing system when executed, the user interface including:
a displayable field including a collection of file information record fields arranged in a generally circular orientation, the collection of file information record fields cyclically accessible in the displayable field and including at least one file record field displaying an image of information contained in a corresponding file held in a remote database, and a plurality of file information record fields displaying less than all of the information contained in corresponding file information records of the database.
